(19) United States
(12) Patent Application Publication
(10) Pub. No.: US 2025/0182769 A1
(43) Pub. Date: Jun. 5, 2025

(54) AUDIO SAMPLE RECONSTRUCTION USING A NEURAL NETWORK AND MULTIPLE SUBBAND NETWORKS

(71) Applicant: QUALCOMM Incorporated, San Diego, CA (US)

(72) Inventors: Zisis Iason SKORDILIS, San Diego, CA (US); Vivek RAJENDRAN, San Diego, CA (US); Stephane VILLETTE, San Diego, CA (US)

(21) Appl. No.: 18/841,304

(22) PCT Filed: Feb. 24, 2023
(86) PCT No.: PCT/US23/63246

§ 371 Date: Aug. 23, 2024

(30) Foreign Application Priority Data
Apr. 26, 2022 (GR) 20220100343

(51) Int. Cl. G10L 19/008; G10L 19/08; G10L 25/30

(52) U.S. Cl. CPC G10L 19/008; G10L 19/08; G10L 25/30

(57) ABSTRACT

A device includes a neural network, a first subband neural network, a second subband neural network, and a reconstructor. The neural network processes neural network inputs to generate a neural network output. The neural network inputs include at least one previous audio sample. The first subband neural network processes first subband network inputs to generate a first subband audio sample. The first subband network inputs include at least the neural network output. The second subband neural network processes second subband network inputs to generate a second subband audio sample. The second subband network inputs include at least the neural network output. The reconstructor generates a reconstructed audio sample based on the first subband audio sample and the second subband audio sample. The at least one previous audio sample includes a previous subband audio sample, a previous reconstructed audio sample, or both.

### I. CROSS-REFERENCE TO RELATED APPLICATIONS

The present application claims the benefit of priority from the commonly owned Greece Patent Application No. 20220100343, filed Apr. 26, 2022, the contents of which are expressly incorporated herein by reference in their entirety.

### II. FIELD

The present disclosure is generally related to audio sample reconstruction using a neural network and multiple subband networks.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices may include the capability to generate sample data, such as reconstructed audio samples. For example, a device may receive encoded audio data that is decoded and processed to generate reconstructed audio samples. The process of generating the reconstructed audio samples using a single neural network tends to have high computation complexity that can result in slower processing and higher memory usage.

### IV. SUMMARY

According to one implementation of the present disclosure, a device includes a neural network, a first subband neural network, a second subband neural network, and a reconstructor. The neural network is configured to process one or more neural network inputs to generate a neural network output. The one or more neural network inputs include at least one previous audio sample. The first subband neural network is configured to process one or more first subband network inputs to generate at least one first subband audio sample of a first reconstructed subband audio signal. The one or more first subband network inputs include at least the neural network output. The first reconstructed subband audio signal corresponds to a first audio subband. The second subband neural network is configured to process one or more second subband network inputs to generate at least one second subband audio sample of a second reconstructed subband audio signal. The one or more second subband network inputs include at least the neural network output. The second reconstructed subband audio signal corresponds to a second audio subband that is distinct from the first audio subband. The reconstructor is configured to generate, based on the at least one first subband audio sample and the at least one second subband audio sample, at least one reconstructed audio sample of an audio frame of a reconstructed audio signal. The at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

According to another implementation of the present disclosure, a method includes processing, using a neural network, one or more neural network inputs to generate a neural network output. The one or more neural network inputs include at least one previous audio sample. The method also includes processing, using a first subband neural network, one or more first subband network inputs to generate at least one first subband audio sample of a first reconstructed subband audio signal. The one or more first subband network inputs include at least the neural network output. The first reconstructed subband audio signal corresponds to a first audio subband. The method further includes processing, using a second subband neural network, one or more second subband network inputs to generate at least one second subband audio sample of a second reconstructed subband audio signal. The one or more second subband network inputs include at least the neural network output. The second reconstructed subband audio signal corresponds to a second audio subband that is distinct from the first audio subband. The method also includes using a reconstructor to generate, based on the at least one first subband audio sample and the at least one second subband audio sample, at least one reconstructed audio sample of an audio frame of a reconstructed audio signal. The at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

According to another implementation of the present disclosure, a non-transitory computer-readable medium includes instructions that, when executed by one or more processors, cause the one or more processors to process, using a neural network, one or more neural network inputs to generate a neural network output. The one or more neural network inputs include at least one previous audio sample. The instructions, when executed by the one or more processors, also cause the one or more processors to process, using a first subband neural network, one or more first subband network inputs to generate at least one first subband audio sample of a first reconstructed subband audio signal. The one or more first subband network inputs include at least the neural network output. The first reconstructed subband audio signal corresponds to a first audio subband. The instructions, when executed by the one or more processors, also cause the one or more processors to process, using a second subband neural network, one or more second subband network inputs to generate at least one second subband audio sample of a second reconstructed subband audio signal. The one or more second subband network inputs include at least the neural network output. The second reconstructed subband audio signal corresponds to a second audio subband that is distinct from the first audio subband. The instructions, when executed by the one or more processors, also cause the one or more processors to generate, based on the at least one first subband audio sample and the at least one second subband audio sample, at least one reconstructed audio sample of an audio frame of a reconstructed audio signal. The at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

According to another implementation of the present disclosure, an apparatus includes means for processing, using a neural network, one or more neural network inputs to generate a neural network output. The one or more neural network inputs include at least one previous audio sample. The apparatus also includes means for processing, using a first subband neural network, one or more first subband network inputs to generate at least one first subband audio sample of a first reconstructed subband audio signal. The one or more first subband network inputs include at least the neural network output. The first reconstructed subband audio signal corresponds to a first audio subband. The apparatus further includes means for processing, using a second subband neural network, one or more second subband network inputs to generate at least one second subband audio sample of a second reconstructed subband audio signal. The one or more second subband network inputs include at least the neural network output. The second reconstructed subband audio signal corresponds to a second audio subband that is distinct from the first audio subband. The apparatus also includes means for generating, based on the at least one first subband audio sample and the at least one second subband audio sample, at least one reconstructed audio sample of an audio frame of a reconstructed audio signal. The at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative aspect of a system operable to perform audio sample reconstruction using a sample generation network that includes a neural network and multiple subband networks, in accordance with some examples of the present disclosure.

FIG. 2 is a diagram of an illustrative aspect of a system operable to perform audio sample reconstruction using the sample generation network of FIG. 1, in accordance with some examples of the present disclosure.

FIG. 3 is a diagram of an illustrative implementation of the sample generation network of FIG. 1, in accordance with some examples of the present disclosure.

FIG. 4 is a diagram of another illustrative implementation of the sample generation network of FIG. 1, in accordance with some examples of the present disclosure.

FIG. 5 is a diagram of an implementation of a subband network of the sample generation network of FIG. 1, in accordance with some examples of the present disclosure.

FIG. 6 is a diagram of an illustrative implementation of a linear prediction (LP) module of the subband network of FIG. 5, in accordance with some examples of the present disclosure.

FIG. 7 is a diagram of illustrative examples of audio subbands corresponding to reconstructed subband audio samples generated by any of the systems of FIGS. 1-2, in accordance with some examples of the present disclosure.

FIG. 8 is a diagram of additional illustrative examples of audio subbands corresponding to reconstructed subband audio samples generated by any of the systems of FIGS. 1-2, in accordance with some examples of the present disclosure.

FIG. 9 is a diagram of additional illustrative examples of audio subbands corresponding to reconstructed subband audio samples generated by any of the systems of FIGS. 1-2, in accordance with some examples of the present disclosure.

FIG. 10 illustrates an example of an integrated circuit operable to perform audio sample reconstruction using a neural network and multiple subband networks, in accordance with some examples of the present disclosure.

FIG. 11 is a diagram of a mobile device operable to perform audio sample reconstruction using a neural network and multiple subband networks, in accordance with some examples of the present disclosure.

FIG. 12 is a diagram of a headset operable to perform audio sample reconstruction using a neural network and multiple subband networks, in accordance with some examples of the present disclosure.

FIG. 13 is a diagram of a wearable electronic device operable to perform audio sample reconstruction using a neural network and multiple subband networks, in accordance with some examples of the present disclosure.

FIG. 14 is a diagram of a voice-controlled speaker system operable to perform audio sample reconstruction using a neural network and multiple subband networks, in accordance with some examples of the present disclosure.

FIG. 15 is a diagram of a camera operable to perform audio sample reconstruction using a neural network and multiple subband networks, in accordance with some examples of the present disclosure.

FIG. 16 is a diagram of a headset, such as a virtual reality, mixed reality, or augmented reality headset, operable to perform audio sample reconstruction using a neural network and multiple subband networks, in accordance with some examples of the present disclosure.

FIG. 17 is a diagram of a first example of a vehicle operable to perform audio sample reconstruction using a neural network and multiple subband networks, in accordance with some examples of the present disclosure.

FIG. 18 is a diagram of a second example of a vehicle operable to perform audio sample reconstruction using a neural network and multiple subband networks, in accordance with some examples of the present disclosure.

FIG. 19 is diagram of a particular implementation of a method of audio sample reconstruction using a neural network and multiple subband networks that may be performed by the device of FIG. 1, in accordance with some examples of the present disclosure.

FIG. 20 is a block diagram of a particular illustrative example of a device that is operable to perform audio sample reconstruction using a neural network and multiple subband networks, in accordance with some examples of the present disclosure.

### VI. DETAILED DESCRIPTION

Audio sample reconstruction using a single neural network tends to have high computation complexity. Systems and methods of audio sample reconstruction using a neural network and multiple subband networks are disclosed. For example, a neural network is configured to generate a neural network output based on neural network inputs. The subband networks generate reconstructed subband audio samples based at least in part on the neural network output. For example, a first subband network generates a first reconstructed subband audio sample that is associated with a first audio subband. A second subband network generates a second reconstructed subband audio sample that is associated with a second audio subband and is based on the first reconstructed subband audio sample. A reconstructor generates a reconstructed audio sample by combining the first reconstructed subband audio sample, the second reconstructed subband audio sample, one or more additional reconstructed subband audio samples, or a combination thereof.

As compared to a single neural network performing all processing for multiple audio subbands, having the neural network perform an initial stage of processing for multiple (e.g., all) audio subbands to generate the neural network output that is processed by multiple subband audio networks reduces complexity. For example, to generate a reconstructed audio signal having a first sample rate (e.g., 16 kilohertz (kHz)), each layer of the single neural network would run 16,000 times per second to generate 16,000 reconstructed audio samples. A neural network that performs the initial stage of processing to generate the neural network output for 2 subband audio networks would run 8000 times per second to output the neural network output (e.g., 16000 samples/2 subband networks=8000 samples). The first subband network runs 8000times per second to process the neural network output to generate 8000 first reconstructed audio samples. The second subband network runs 8000 times per second to process the neural network output to generate 8000 second reconstructed audio samples. The reconstructor outputs 16000 reconstructed audio samples (e.g., based on 8000 first reconstructed audio samples+8000 second reconstructed audio samples) per second. Having the neural network run 8000 times per second reduces complexity, as compared to having the neural network run 16000 times per second. The separate subband networks, with each subsequent subband network processing an output of a previous subband network, account for any dependencies between audio subbands. The reduced complexity can increase processing speed, reduce memory usage, or both, while the multiple subband networks account for dependencies between audio subbands.

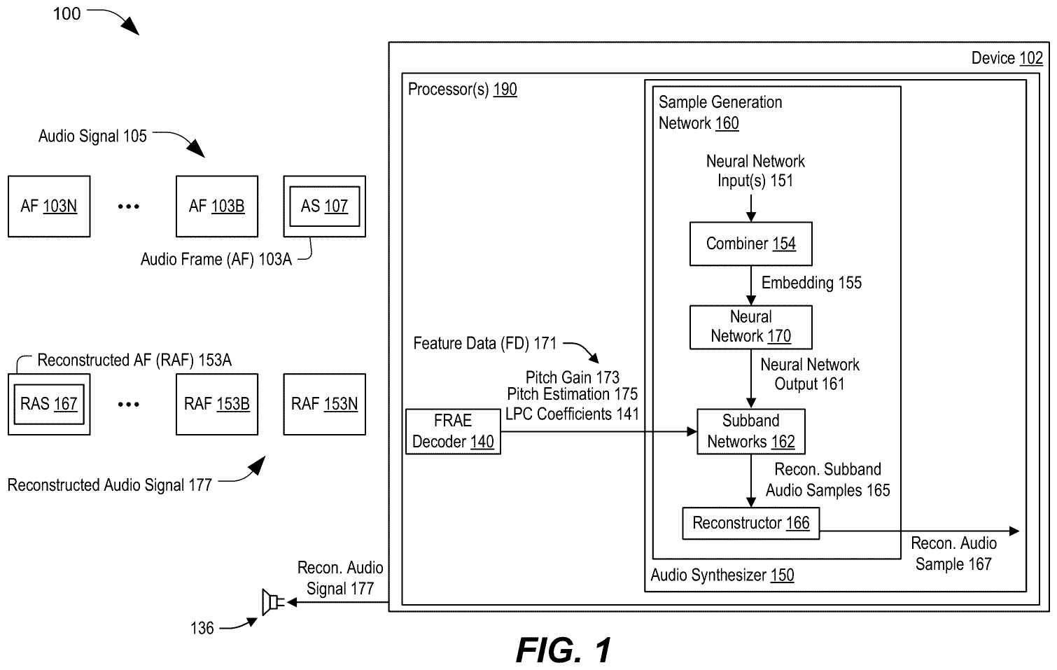

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular unless aspects related to multiple of the features are being described. In some drawings, multiple instances of a particular type of feature are used. Although these features are physically and/or logically distinct, the same reference number is used for each, and the different instances are distinguished by addition of a letter to the reference number.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

Referring to FIG. 1, a particular illustrative aspect of a system 100 configured to perform audio sample reconstruction is shown. The system 100 includes a neural network 170 and subband networks 162 (e.g., subband neural networks).

The device 102 includes one or more processors 190. A sample generation network 160 of the one or more processors 190 includes a combiner 154 coupled via the neural network 170 to the subband networks 162. The subband networks 162 are coupled to a reconstructor 166. In a particular aspect, the sample generation network 160 is included in an audio synthesizer 150.

In some implementations, the system 100 corresponds to an audio coding system. For example, an audio decoder (e.g., a feedback recurrent autoencoder (FRAE) decoder 140) is coupled to the audio synthesizer 150. To illustrate, in a particular aspect, the FRAE decoder 140 is coupled to the subband networks 162. The one or more processors 190 are coupled to one or more speakers 136. In some implementations, the one or more speakers 136 are external to the device 102. In other implementations, the one or more speakers 136 are integrated in the device 102.

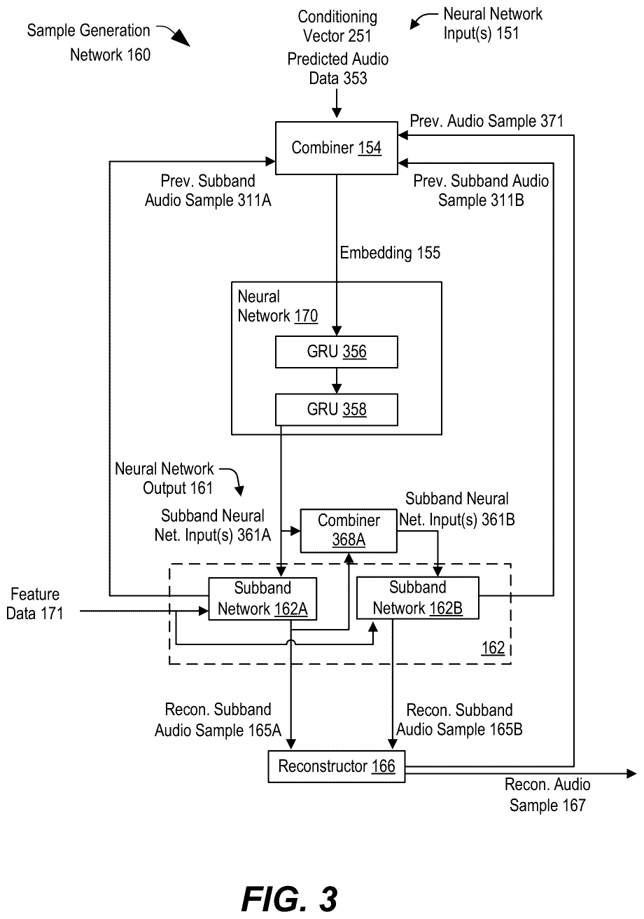

The FRAE decoder 140 is configured to generate feature data (FD) 171. For example, the feature data 171 includes linear predictive coefficients (LPCs) 141, a pitch gain 173, a pitch estimation 175, or a combination thereof. The LPCs 141, the pitch gain 173, and the pitch estimation 175 are provided as illustrative examples of types of feature data included in the feature data 171. In other examples, the feature data 171 can additionally or alternatively include various other types of feature data, such as Bark cepstrum, Bark spectrum, Mel spectrum, magnitude spectrum, or a combination thereof. One or more of the types of feature data can be in linear or log amplitude domain. The combiner 154 is configured to process one or more neural network inputs 151 to generate an embedding 155, as further described with reference to FIG. 3. The neural network 170 is configured to process the embedding 155 to generate a neural network output 161. In some implementations, the neural network 170 includes an autoregressive (AR) generative neural network. For example, the neural network 170 is configured to process an embedding that is based on previous output of the subband networks 162, the reconstructor 166, or both, to generate the neural network output 161 that is used by the subband networks 162 to generate subsequent output, as further described with reference to FIG. 3. In some aspects, the neural network 170 includes a convolutional neural network (CNN), WaveNet, PixelCNN, a transformer network with an encoder and a decoder, Bidirectional Encoder Representations from Transformers (Bert), another type of AR generative neural network, another type of neural network, or a combination thereof.

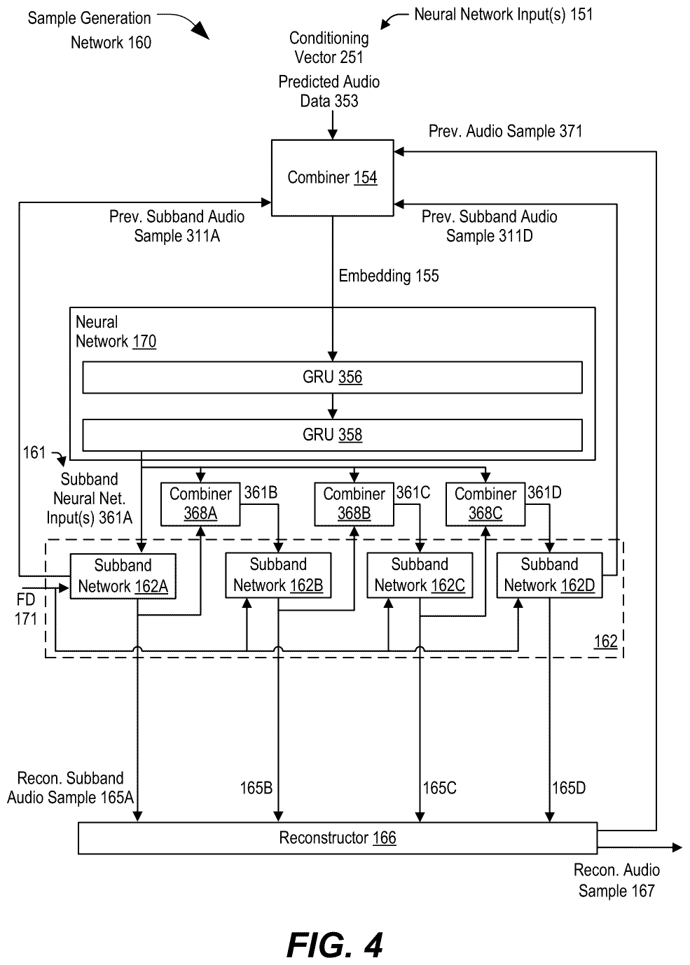

The subband networks 162 are configured to generate reconstructed subband audio samples 165 based on the neural network output 161, the feature data 171, or both, as further described with reference to FIG. 4. The reconstructor 166 (e.g., a subband reconstruction filterbank) is configured to generate a reconstructed audio sample 167 of a reconstructed audio signal 177 based on the reconstructed subband audio samples 165 generated during one or more iterations by the subband networks 162.

In some implementations, an audio signal 105 is captured by one or more microphones, converted from an analog signal to a digital signal by an analog-to-digital converter, and compressed by an encoder for storage or transmission. In these implementations, the FRAE decoder 140 performs an inverse of a coding algorithm used by the encoder to decode the compressed signal to generate the feature data 171. In other implementations, the audio signal 105 (e.g., a compressed digital signal) is generated by an audio application of the one or more processors 190, and the FRAE decoder 140 decodes the compressed digital signal to generate the feature data 171. The audio signal 105 can include a speech signal, a music signal, another type of audio signal, or a combination thereof.

The FRAE decoder 140 is provided as an illustrative example of an audio decoder. In some examples, the one or more processors 190 can include any type of audio decoder that generates the feature data 171, using a suitable audio coding algorithm, such as a linear prediction coding algorithm (e.g., Code-Excited Linear Prediction (CELP), algebraic CELP (ACELP), or other linear prediction technique), or another audio coding algorithm.

The audio signal 105 can be divided into blocks of samples, where each block is referred to as a frame. For example, the audio signal 105 includes a sequence of audio frames, including an audio frame (AF) 103A, an audio frame 103B, one or more additional audio frames, an audio frame 103N, or a combination thereof. In some examples, each of the audio frames 103A-N represents audio corresponding to 10-20 milliseconds (ms) of playback time, and each of the audio frames 103A-N includes about 160 audio samples.

In some examples, the reconstructed audio signal 177 corresponds to a reconstruction of the audio signal 105. For example, a reconstructed audio frame (RAF) 153A includes a representative reconstructed audio sample (RAS) 167 that corresponds to a reconstruction (e.g., an estimation) of a representative audio sample (AS) 107 of the audio frame 103A. The audio synthesizer 150 is configured to generate the reconstructed audio frame 153A based on the reconstructed audio sample 167, one or more additional reconstructed audio samples, or a combination thereof (e.g., about 160 reconstructed audio samples including the reconstructed audio sample 167). The reconstructed audio signal 177 includes the reconstructed audio frame 153A as a reconstruction or estimation of the audio frame 103A.

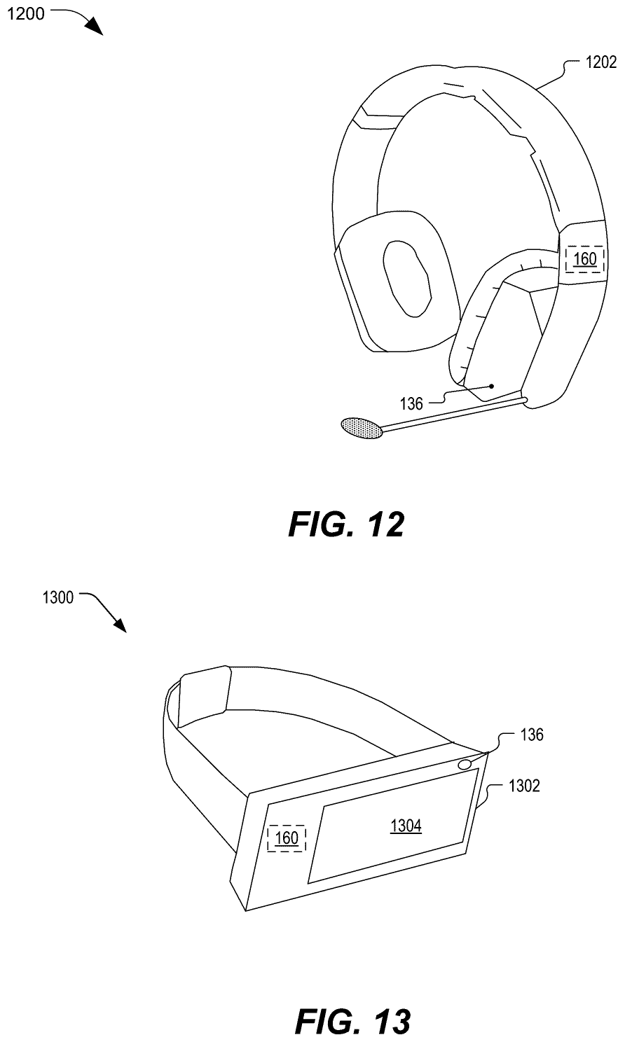

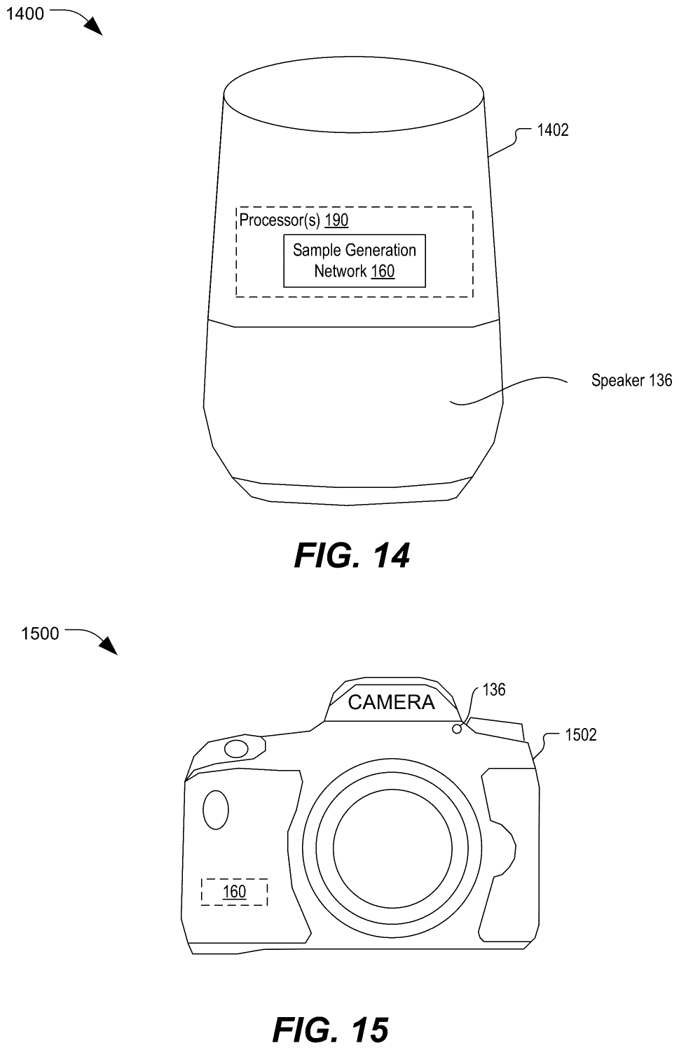

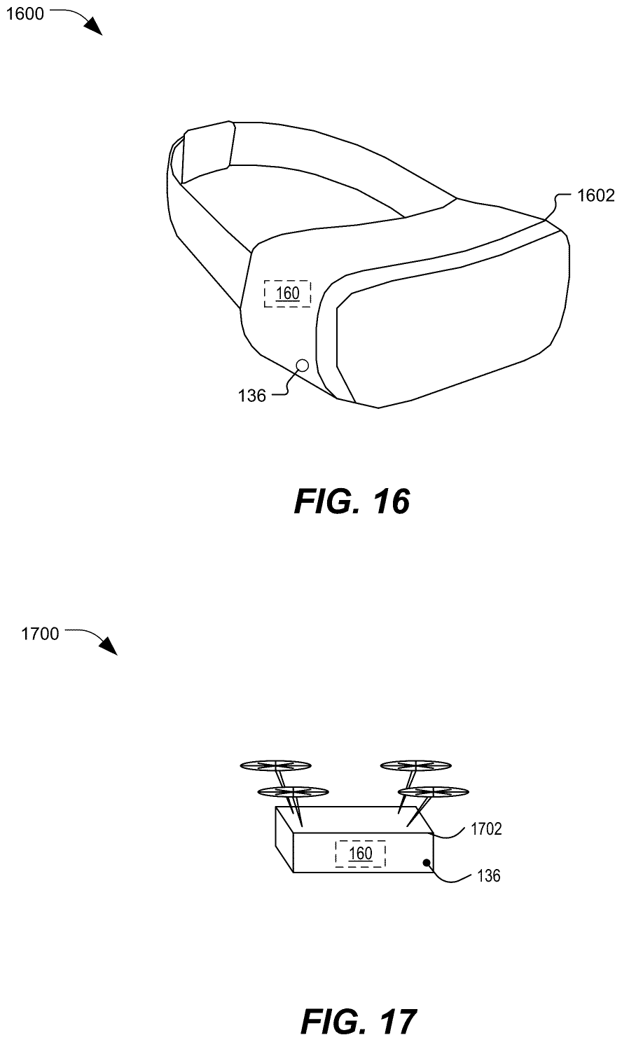

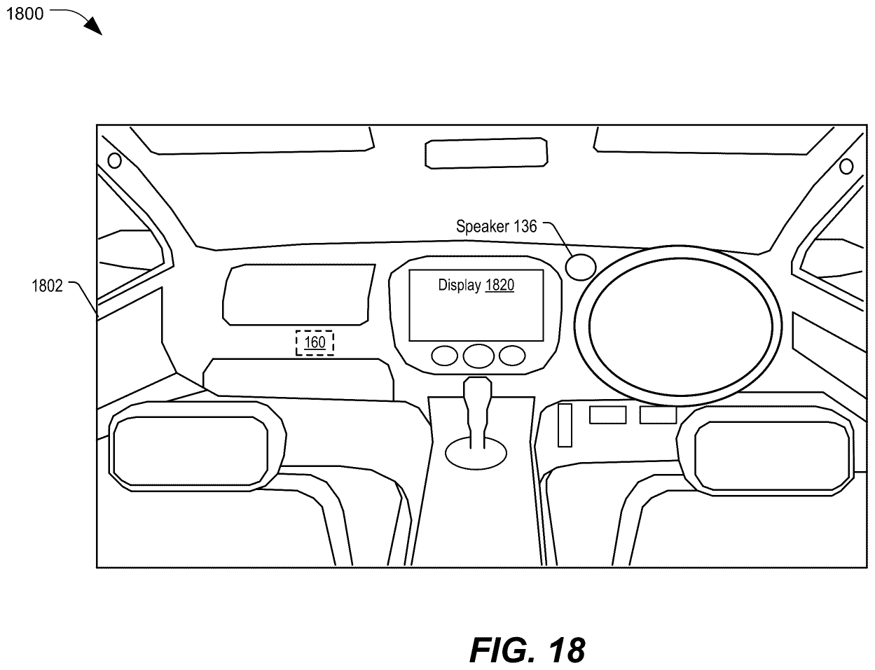

In some implementations, the device 102 corresponds to or is included in one of various types of devices. In an illustrative example, the one or more processors 190 are integrated in a headset device, such as described further with reference to FIG. 12. In other examples, the one or more processors 190 are integrated in at least one of a mobile phone or a tablet computer device, as described with reference to FIG. 11, a wearable electronic device, as described with reference to FIG. 13, a voice-controlled speaker system, as described with reference to FIG. 14, a camera device, as described with reference to FIG. 15, or a virtual reality, mixed reality, or augmented reality headset, as described with reference to FIG. 16. In another illustrative example, the one or more processors 190 are integrated into a vehicle, such as described further with reference to FIG. 17 and FIG. 18.

During operation, the FRAE decoder 140 generates the feature data 171 representing the audio frame 103A. In some implementations, the FRAE decoder 140 generates at least a portion of the feature data 171 (e.g., one or more of the LPCs 141, the pitch gain 173, or the pitch estimation 175) by decoding corresponding encoded versions of the portion of the feature data 171 (e.g., the LPCs 141, the pitch gain 173, or the pitch estimation 175). In some implementations, at least a portion of the feature data 171 (e.g., one or more of the LPCs 141, the pitch gain 173, or the pitch estimation 175) is estimated independently of corresponding encoded versions of the portion of the feature data 171 (e.g., the LPCs 141, the pitch gain 173, or the pitch estimation 175). To illustrate, a component (e.g., the FRAE decoder 140, a digital signal processor (DSP) block, or another component) of the one or more processors 190 can estimate a portion of the feature data 171 based on an encoded version of another portion of the feature data 171. For example, the pitch estimation 175 can be estimated based on a speech cepstrum. As another example, the LPCs 141 can be generated by processing various audio features, such as pitch lag, pitch correlation, the pitch gain 173, the pitch estimation 175, Bark-frequency cepstrum of a speech signal, or a combination thereof, of the audio frame 103A. In a particular aspect, the FRAE decoder 140 provides the decoded portions of the feature data 171 to the subband networks 162. In a particular aspect, the component (e.g., the FRAE decoder 140, the DSP block, or another component) of the one or more processors 190 provides the estimated portions of the feature data 171 to the subband networks 162.

The sample generation network 160 generates a reconstructed audio sample 167, as further described with reference to FIG. 4. For example, the combiner 154 combines neural network inputs 151 to generate an embedding 155 that is provided to the neural network 170. The neural network 170 (e.g., a first stage network) processes the embedding 155 to generate a neural network output 161. In a particular aspect, using the neural network 170 to generate the neural network output 161 to perform an initial stage of processing for multiple (e.g., all) audio subbands reduces complexity. The neural network 170 provides the neural network output 161 to the subband networks 162.

The subband networks 162 process the neural network output 161 and the feature data 171 to generate reconstructed subband audio samples 165. For example, each of the subband networks 162 generates one of the reconstructed subband audio samples 165 associated with a corresponding audio subband, as further described with reference to FIGS. 3-4. Each subsequent subband network of the subband networks 162 generates a reconstructed subband audio sample associated with an audio subband of the reconstructed audio sample 167 that is based on a reconstructed subband audio sample generated by a previous subband network of the subband networks 162, and thus takes account of any dependencies between the audio subbands.

The reconstructor 166 combines the reconstructed subband audio samples 165 generated during one or more iterations by the subband networks 162 to generate the reconstructed audio sample 167. In a particular aspect, the reconstructor 166 includes a subband reconstruction filterbank, such as a quadrature mirror filter (QMF), a pseudo QMF, a Gabor filterbank, etc. The reconstructor 166 can perform sub-band processing that is either critically sampled or oversampled. Oversampling enables transfer ripple vs aliasing operating points that are not possible to achieve with critical sampling. For example, for a particular transfer ripple specification, a critically sampled filterbank can limit aliasing to at most a particular threshold level, but an oversampled filterbank could decrease aliasing further while maintaining the same transfer ripple specification. Oversampling reduces some burden from the subband networks 162 in terms of the subband networks 162 trying to match aliasing components across audio sub-bands with precision to achieve aliasing cancellation. Even if aliasing components don't match precisely and the aliasing does not exactly cancel, the final output quality of the reconstructed audio sample 167 is likely to be acceptable if aliasing within each sub- band is relatively low to begin with.

In a particular aspect, the reconstructed audio sample 167 corresponds to a reconstruction of the audio sample 107 of the audio frame 103A of the audio signal 105. The audio synthesizer 150 generates the reconstructed audio frame 153A including at least the reconstructed audio sample 167.

Similarly, the audio synthesizer 150 (e.g., the sample generation network 160) generates a reconstructed audio frame 153B corresponding to a reconstruction or estimation of the audio frame 103B, one or more additional reconstructed audio frames, a reconstructed audio frame 153N corresponding to a reconstruction or estimation of the audio frame 103N, or a combination thereof. The reconstructed audio signal 177 includes the reconstructed audio frame 153A, the reconstructed audio frame 153B, the one or more additional reconstructed audio frames, the reconstructed audio frame 153N, or a combination thereof.

In some aspects, the audio synthesizer 150 outputs the reconstructed audio signal 177 via the one or more speakers 136. In some examples, the device 102 provides the reconstructed audio signal 177 to another device, such as a storage device, a user device, a network device, a playback device, or a combination thereof. In some aspects, the reconstructed audio signal 177 includes a reconstructed speech signal, a reconstructed music signal, a reconstructed animal sound signal, a reconstructed noise signal, or a combination thereof.

In some implementations, the subband networks 162 provide the reconstructed subband audio samples 165, the reconstructor 166 provides the reconstructed audio sample 167, or both, to the combiner 154 as part of the neural network inputs 151 for a subsequent iteration.

By having the neural network 170 perform an initial stage of processing to generate the neural network output 161, the system 100 reduces complexity, thereby reducing processing time, memory usage, or both. By having each subsequent subband network of the subband networks 162 generate a reconstructed audio sample associated with a corresponding audio subband that is based on a reconstructed audio sample generated by a previous subband network of the subband network 162, the system 100 accounts for dependencies between subbands, thereby reducing discontinuity between subbands.

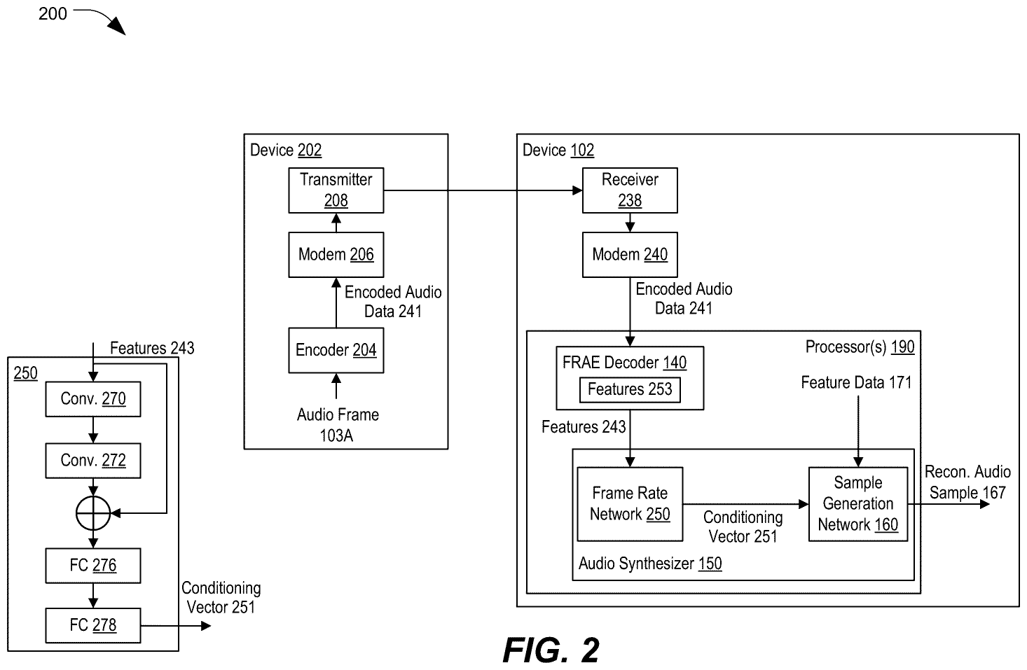

Referring to FIG. 2, a diagram of an illustrative aspect of a system 200 operable to perform audio sample reconstruction using the sample generation network 160 is shown. In some aspects, the system 100 includes one or more components of the system 200.

The system 200 includes a device 202 configured to communicate with the device 102. The device 202 includes an encoder 204 coupled via a modem 206 to a transmitter 208. The device 102 includes a receiver 238 coupled via a modem 240 to the FRAE decoder 140. The audio synthesizer 150 includes a frame rate network 250 coupled to the sample generation network 160. The FRAE decoder 140 is coupled to the frame rate network 250.

In some aspects, the encoder 204 of the device 202 uses an audio coding algorithm to process the audio signal 105 of FIG. 1. For example, the audio signal 105 can include a digitized audio signal. In some implementations, the digitized audio signal is generated using a filter to eliminate aliasing, a sampler to convert to discrete- time, and an analog-to-digital converter for converting an analog signal to the digital domain. The resulting digitized audio signal is a discrete-time audio signal with samples that are also discretized. Using the audio coding algorithm, the encoder 204 can generate a compressed audio signal that represents the audio signal 105 using as few bits as possible, while attempting to maintain a certain quality level for audio. The audio coding algorithm can include a linear prediction coding algorithm (e.g., CELP, ACELP, or other linear prediction technique) or other voice coding algorithm.

As an example, the encoder 204 uses an audio coding algorithm to encode the audio frame 103A of the audio signal 105 to generate encoded audio data 241 of the compressed audio signal. The modem 206 initiates transmission of the compressed audio signal (e.g., the encoded audio data 241) via the transmitter 208. The modem 240 of the device 102 receives the compressed audio signal (e.g., the encoded audio data 241) via the receiver 238, and provides the compressed audio signal (e.g., the encoded audio data 241) to the FRAE decoder 140.

The FRAE decoder 140 decodes the compressed audio signal to extract features representing the audio signal 105 and provides the features to the audio synthesizer 150 to generate the reconstructed audio signal 177. For example, the FRAE decoder 140 decodes the encoded audio data 241 to generate features 253 representing the audio frame 103A.

The features 253 can include any set of features of the audio frame 103A generated by the encoder 204. In some implementations, the features 253 can include quantized features. In other implementations, the features 253 can include dequantized features. In a particular aspect, the features 253 includes the LPCs 141, the pitch gain 173, the pitch estimation 175, pitch lag with fractional accuracy, the Bark cepstrum of a speech signal, the 18-band Bark-frequency cepstrum, an integer pitch period (or lag) (e.g., between 16 and 256 samples), a fractional pitch period (or lag), a pitch correlation (e.g., between 0 and 1), or a combination thereof. In some implementations, the features 253 can include features for one or more (e.g., two) audio frames preceding the audio frame 103A in a sequence of audio frames, the audio frame 103A, one or more (e.g., two) audio frames subsequent to the audio frame 103A in the sequence of audio frames, or a combination thereof.

In a particular aspect, the features 253 explicitly include at least a portion of the feature data 171 (e.g., the LPCs 141, the pitch gain 173, the pitch estimation 175, or a combination thereof), and the FRAE decoder 140 provides at least the portion of the feature data 171 (e.g., the LPCs 141, the pitch gain 173, the pitch estimation 175, or a combination thereof) to the sample generation network 160.

In a particular aspect, the features 253 extracted from the encoded audio data 241 do not explicitly include a particular feature (e.g., the LPCs 141, the pitch gain 173, the pitch estimation 175, or a combination thereof), and the particular feature is estimated based on other features explicitly included in the features 253. For example, the FRAE decoder 140 provides one or more features explicitly included in the features 253 to another component (e.g., a DSP block) of the one or more processors 190 to generate the particular feature, and the other component provides the particular feature to the sample generation network 160. To illustrate, in implementations in which the features 253 do not explicitly include the LPCs 141 and include a Bark cepstrum, the LPCs 141 can be estimated based on the Bark cepstrum. To illustrate, the LPCs 141 are estimated by converting an 18-band Bark-frequency cepstrum into a linear-frequency spectral density (e.g., power spectral density (PSD)), using an inverse Fast Fourier Transform (iFFT) to convert the linear-frequency spectral density (e.g., the PSD) to an auto-correlation, and using the Levinson-Durbin algorithm on the auto-correlation to determine the LPCs 141. As another example, in implementations in which the features 253 do not explicitly include the pitch estimation 175 and include a speech cepstrum of the audio frame 103A, the pitch estimation 175 can be estimated based on the speech cepstrum.

In some aspects, the FRAE decoder 140 provides one or more features 243 of the features 253 to the frame rate network 250 to generate a conditioning vector 251. In a particular implementation, the frame rate network 250 includes a convolutional (conv.) layer 270, a convolutional layer 272, a fully connected (FC) layer 276, and a fully connected layer 278. The convolutional layer 270 processes the features 243 to generate an output that is provided to the convolutional layer 272. In some cases, the convolutional layer 270 and the convolutional layer 272 include filters of the same size. For example, the convolutional layer 270 and the convolutional layer 272 can include a filter size of 3, resulting in a receptive field of five audio frames (e.g., features of two preceding audio frames, the audio frame 103A, and two subsequent audio frames). The output of the convolutional layer 272 is added to the features 243 and is then processed by the fully connected layer 276 to generate an output that is provided as input to the fully connected layer 278. The fully connected layer 278 processes the input to generate the conditioning vector 251.

The frame rate network 250 provides the conditioning vector 251 to the sample generation network 160. In one illustrative example, the conditioning vector 251 is a 128-dimensional vector. In some aspects, the conditioning vector 251, the feature data 171 (e.g., the LPCs 141, the pitch gain 173, the pitch estimation 175, or a combination thereof), or both, can be held constant for the duration of processing each audio frame. The sample generation network 160 generates the reconstructed audio sample 167 based on the conditioning vector 251, the feature data 171, or both, as further described with reference to FIGS. 3-4. In a particular aspect, the reconstructed audio frame 153A includes at least the reconstructed audio sample 167.

In some implementations, each of the FRAE decoder 140 and the frame rate network 250 is configured to process data at a frame rate (e.g., once per 10 ms audio frame). In some implementations, the sample generation network 160 processes data at a sample rate (e.g., one reconstructed audio sample generated per iteration).

Referring to FIG. 3, a diagram of an illustrative implementation of the sample generation network 160 is shown. The sample generation network 160 includes a combiner 154 coupled via a neural network 170 to the subband networks 162.

In a particular aspect, the neural network 170 is coupled via one or more combiners to one or more of the subband networks 162. For example, the neural network 170 is coupled to a subband network 162A, and the neural network 170 is coupled via a combiner 368A to a subband network 162B.

In some aspects, the neural network 170 corresponds to a first stage during which the embedding 155 representing the neural network inputs 151 is processed using a combined network, and the subband networks 162 correspond to a second stage during which each set of subband network input (that is based on the neural network output 161) is processed separately using a respective subband network to generate a corresponding reconstructed subband audio sample.

The neural network 170 is configured to process the embedding 155 to generate the neural network output 161. The neural network 170 includes a plurality of recurrent layers. A recurrent layer includes a gated recurrent unit (GRU), such as a GRU 356. In a particular aspect, the plurality of recurrent layers includes a first recurrent layer including the GRU 356, a second recurrent layer including a GRU 358, one or more additional recurrent layers, or a combination thereof.

The combiner 154 is coupled to the first recurrent layer (e.g., the GRU 356) of the plurality of recurrent layers, the GRU of each previous recurrent layer is coupled to the GRU of a subsequent recurrent layer, and the GRU (e.g., the GRU 358) of a last recurrent layer (e.g., the second recurrent layer) is coupled to the subband networks 162.

The neural network 170 including two recurrent layers is provided as an illustrative example. In other examples, the neural network 170 can include fewer than two or more than two recurrent layers. In some implementations, the neural network 170 may include one or more additional layers, one or more additional connections, or a combination thereof, that are not shown for ease of illustration.

The combiner 154 is configured to process the one or more neural network inputs 151 to generate the embedding 155. The one or more neural network inputs 151 includes the conditioning vector 251, a previous subband audio sample 311A, a previous subband audio sample 311B, a previous audio sample 371, predicted audio data 353, or a combination thereof.

In a particular aspect, the previous subband audio sample 311A is generated by the subband network 162A during a previous iteration. In a particular aspect, the previous subband audio sample 311B is generated by the subband network 162B during the previous iteration. In a particular aspect, the predicted audio data 353 includes predicted audio data generated by a LP module of the subband network 162A during one or more previous iterations, predicted audio data generated by a LP module of the subband network 162B during one or more previous iterations, or both.

The plurality of recurrent layers of the neural network 170 is configured to process the embedding 155. In some implementations, the GRU 356 determines a first hidden state based on a previous first hidden state and the embedding 155. The previous first hidden state is generated by the GRU 356 during the previous iteration. The GRU 356 outputs the first hidden state to the GRU 358. The GRU 358 determines a second hidden state based on the first hidden state and a previous second hidden state. The previous second hidden state is generated by the GRU 358 during the previous iteration. Each previous GRU outputs a hidden state to a subsequent GRU of the plurality of recurrent layers and the subsequent GRU generates a hidden state based on the received hidden state and a previous hidden state. The neural network output 161 is based on the hidden state of the GRU of the last recurrent layer (e.g., the GRU 358). The neural network 170 outputs the neural network output 161 to the subband network 162A and to the combiner 368A.

In some examples, the one or more neural network inputs 151 can be mu-law encoded and embedded using a network embedding layer of the combiner 154 to generate the embedding 155. For instance, the embedding 155 can map (e.g., in an embedding matrix) each mu-law level to a vector, essentially learning a set of non-linear functions to be applied to the mu-law value. The embedding matrix (e.g., the embedding 155) can be sent to one or more of the plurality of recurrent layers (e.g., the GRU 356, the GRU 358, or a combination thereof). For example, the embedding matrix (e.g., the embedding 155) can be input to the GRU 356, and the output of the GRU 356 can be input to the GRU 358. In another example, the embedding matrix (e.g., the embedding 155) can be separately input to the GRU 356, to the GRU 358, or both.

In some aspects, the product of an embedding matrix that is input to a GRU with a corresponding submatrix of the non-recurrent weights of the GRU can be computed. A transformation can be applied for all gates (e.g., update gate (u), reset gate (r), and hidden state (h)) of the GRU and all of the embedded inputs (e.g., the one or more neural network inputs 151). In some cases, one or more of the one or more neural network inputs 151 may not be embedded, such as the conditioning vector 251. Using the previous subband audio sample 311A as an example of an embedded input, E can denote the embedding matrix and U^{(u,s)} can denote a submatrix of U⁽ⁿ⁾ including the columns that apply to the embedding of the previous subband audio sample 311A, and a new embedding matrix V^{(u,s)}=U^{(u,s)}E can be derived that directly maps the previous subband audio sample 311A to the non-recurrent term of the update gate computation.

The output from the GRU 358, or outputs from the GRU 356 and the GRU 358 when the embedding matrix (e.g., the embedding 155) is input separately to the GRU 356 and to the GRU 358, are provided as the neural network output 161 to the subband networks 162 and the combiner 368A. For example, the neural network 170 provides the neural network output 161 as one or more subband neural network inputs 361A to the subband network 162A and to the combiner 368A.

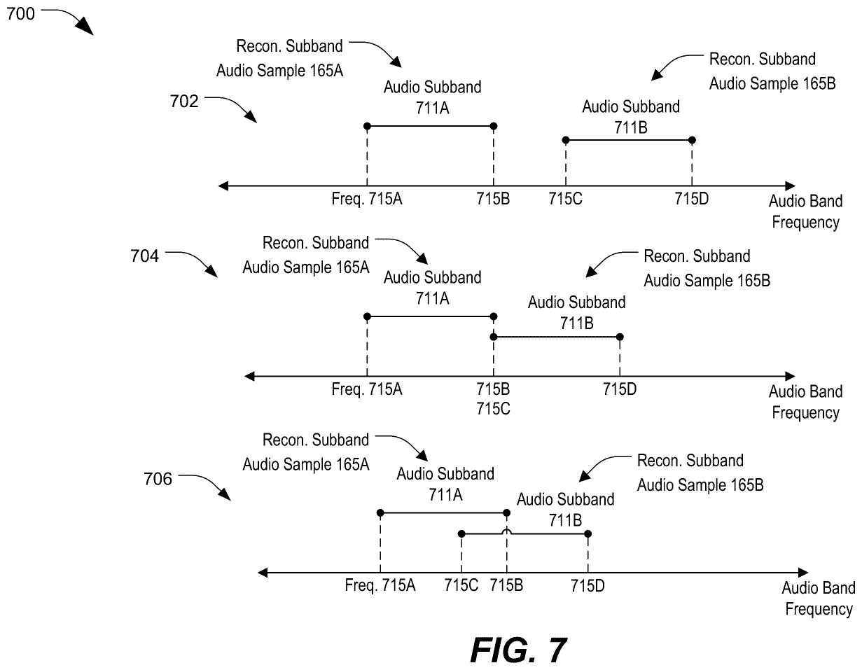

Each of the subband networks 162 generates a reconstructed subband audio sample of a reconstructed subband audio signal of the reconstructed audio signal 177. To illustrate, a first reconstructed subband audio signal of the reconstructed audio signal 177 corresponds to at least a first audio subband, and a second reconstructed subband audio signal of the reconstructed audio signal 177 corresponds to at least a second audio subband. The first audio subband is associated with a first range of frequencies, and the second audio subband is associated with a second range of frequencies, as further described with reference to FIGS. 7-9.

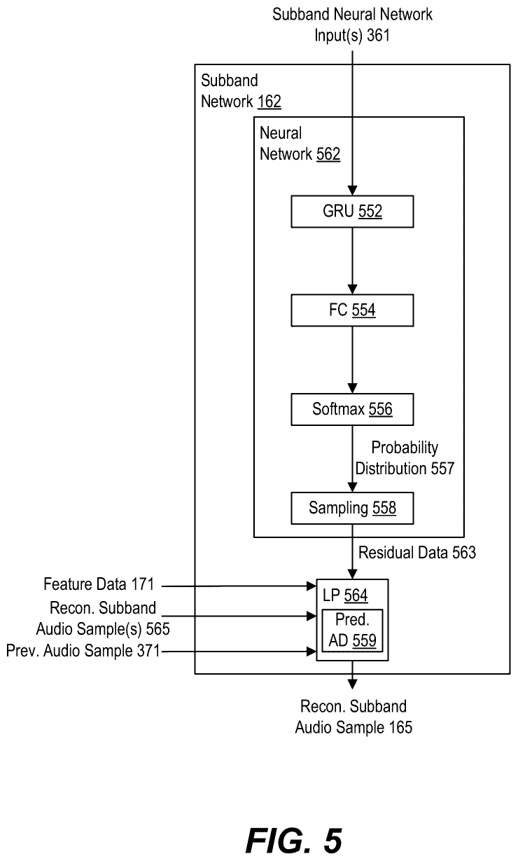

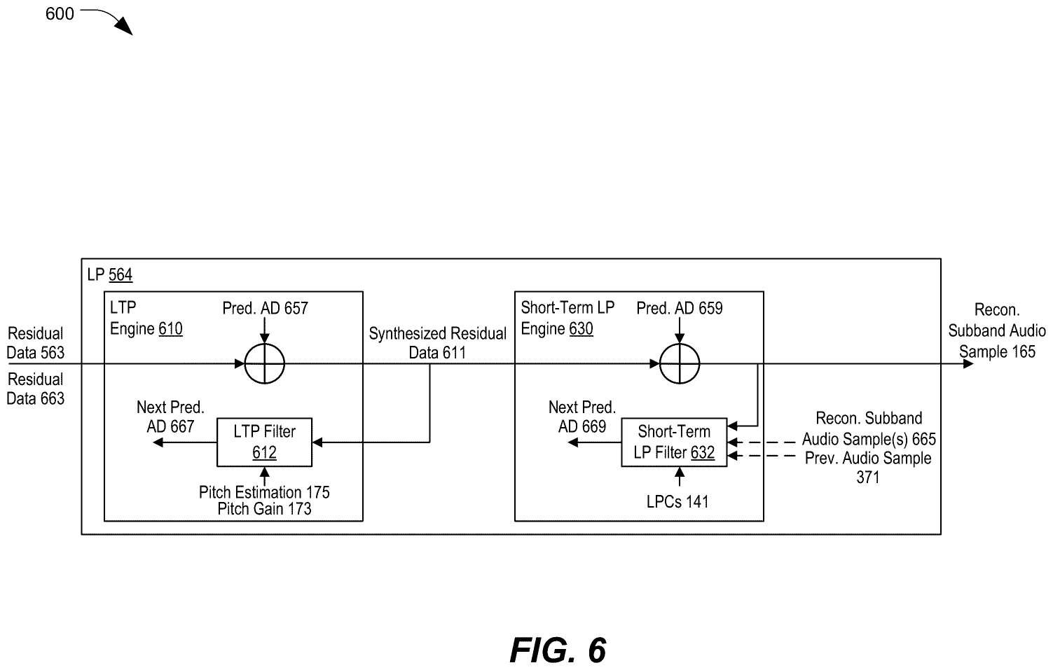

For example, the subband network 162A processes the one or more subband neural network inputs 361A based at least in part on the feature data 171 to generate a reconstructed subband audio sample 165A of a first reconstructed subband audio signal of the reconstructed audio signal 177. For example, the subband network 162A generates the reconstructed subband audio sample 165A based on the feature data 171, the previous subband audio sample 311A, the previous audio sample 371, predicted audio data (e.g., at least a portion of the predicted audio data 353), or a combination thereof, as further described with reference to FIGS. 5 and 6.

The combiner 368A combines the one or more subband neural network inputs 361A and the reconstructed subband audio sample 165A to generate one or more subband neural network inputs 361B. The subband network 162B processes the one or more subband neural network inputs 361B based at least in part on the feature data 171 to generate a reconstructed subband audio sample 165B of a second reconstructed subband audio signal of the reconstructed audio signal 177. For example, the subband network 162B generates the reconstructed subband audio sample 165B based on the feature data 171, the previous subband audio sample 311A, the previous subband audio sample 311B, the previous audio sample 371, predicted audio data (e.g., at least a portion of the predicted audio data 353), the reconstructed subband audio sample 165A, or a combination thereof, as further described with reference to FIGS. 5 and 6.

The subband networks 162 including two subband networks is provided as an illustrative example. In other examples, the subband networks 162 includes more than two subband networks (i.e., a particular count of subband networks that is greater than two, such as four subband networks).

The reconstructor 166 combines reconstructed subband audio samples generated during one or more iterations by the subband networks 162 to generate a reconstructed audio sample 167. For example, the reconstructor 166 combines the reconstructed subband audio sample 165A, the reconstructed subband audio sample 165B, one or more additional subband audio samples, or a combination thereof, to generate the reconstructed audio sample 167.

In a particular implementation, the reconstructor 166 combines one or more subband audio samples generated in a previous iteration (e.g., the previous subband audio sample 311A, the previous subband audio sample 311B, one or more additional subband audio samples, or a combination thereof) to generate a previous reconstructed audio sample. In another particular implementation, the reconstructor 166 combines one or more subband audio samples generated in a previous iteration (e.g., the previous subband audio sample 311A, the previous subband audio sample 311B, or both), one or more subband audio samples generated in a current iteration (e.g., the reconstructed subband audio sample 165A, the reconstructed subband audio sample 165B, or both), one or more additional subband audio samples, or a combination thereof, to generate the reconstructed audio sample 167.

In a particular aspect, the subband networks 162, the reconstructor 166, or both, generate at least a portion of the one or more neural network inputs 151 for a subsequent iteration. For example, the subband network 162A provides the reconstructed subband audio sample 165A as a previous subband audio sample 311A for a subsequent iteration. As another example, the subband network 162B provides the reconstructed subband audio sample 165B as a previous subband audio sample 311B for the subsequent iteration. In a particular aspect, the reconstructor 166 provides the reconstructed audio sample 167 as a previous audio sample 371 for the subsequent iteration. In a particular implementation, the subband network 162A provides at least a first portion of the predicted audio data 353 for the subsequent iteration. In a particular implementation, the subband network 162B provides at least a second portion of the predicted audio data 353 for the subsequent iteration.

The subband network 162A and the subband network 162B are described as separate modules for ease of illustration. In other examples, the same subband network generates the reconstructed subband audio sample 165B subsequent to generating the reconstructed subband audio sample 165A.

In some examples, the reconstructor 166 is configured to generate multiple reconstructed audio samples of the reconstructed audio signal 177 per inference of the neural network 170. For example, the reconstructor 166 can generate multiple reconstructed audio samples from the reconstructed subband audio sample 165A, the reconstructed subband audio sample 165B, one or more additional reconstructed audio samples, or a combination thereof. In an illustrative example, the reconstructor 166 includes a critically sampled 2-band filterbank. The audio signal 105 (e.g., s[n]) has a first sample rate (e.g., 16 kHz) and is encoded as a first subband audio signal (e.g., s_L[n]) and a second subband audio signal (e.g., s_H[n]).

In a particular aspect, the first subband audio signal (e.g., s_L[n]) corresponds to a first audio subband that includes a first frequency range. The second subband audio signal (e.g., s_H[n]) corresponds to a second audio band that includes a second frequency range that is distinct from the first frequency range. As an example, the first frequency range is from a first start frequency to a first end frequency, and the second frequency range is from a second start frequency to a second end frequency. In a particular example, the second start frequency is adjacent and subsequent to the first end frequency. Each of the first subband audio signal (e.g., s_L[n]) and the second subband audio signal (e.g., s_H[n]) has a second sample rate (e.g., 8 kHz) that is half of the first sample rate (e.g., 16 kHz).

The reconstructor 166 generates a first reconstructed subband audio signal (e.g., including the reconstructed subband audio sample 165A) and a second reconstructed audio signal (e.g., including the reconstructed subband audio sample 165B) that represent reconstructed versions of the first subband audio signal and the second subband audio signal, respectively.

The reconstructor 166 upsamples and filters each of the first reconstructed subband audio signal and the second reconstructed audio signal, and adds the resultant upsampled filtered signals to generate the reconstructed audio signal 177, which has twice the sample rate of the first reconstructed subband audio signal and the second reconstructed audio signal. Thus, a frame of N reconstructed samples of the first reconstructed subband audio signal (e.g., s_L) and a corresponding frame of N reconstructed samples of the second reconstructed subband audio signal (e.g., s_H) input to the reconstructor 166 results in an output of 2N reconstructed samples of the reconstructed audio signal 177. The reconstructor 166 can thus generate multiple reconstructed audio samples (e.g., two reconstructed audio samples) based on the reconstructed subband audio sample 165A and the reconstructed subband audio sample 165B in each iteration.

In some implementations, during a first processing stage of an iteration, the subband network 162A generates the reconstructed subband audio sample 165A that is used by the reconstructor 166 during the generation of two reconstructed audio samples. During a second processing stage of the iteration, the subband network 162B generates the reconstructed subband audio sample 165B that is also used by the reconstructor 166 during the generation of the two reconstructed audio samples. In some aspects, the subband network 162B is idle during the first processing stage and the subband network 162A is idle during the second processing stage. Each of the subband network 162A and the subband network 162B operates at a sample rate (e.g., 8 kHz) that is half of the first sample rate (e.g., 16 kHz) of the reconstructed audio signal 177. For example, each of the subband network 162A and the subband network 162B generates data used to generate two reconstructed audio samples every two processing stages.

Referring to FIG. 4, a diagram of an illustrative implementation of the sample generation network 160 is shown. In a particular aspect, each of the subband networks 162 is configured to generate a reconstructed subband audio sample based at least in part on the neural network output 161.

The subband networks 162 include the subband network 162A, the subband network 162B, a subband network 162C, and a subband network 162D. The neural network 170 is coupled to the combiner 368A, a combiner 368B, and a combiner 368C. The combiner 368A is coupled to the subband network 162A and to the subband network 162B. The combiner 368B is coupled to the subband network 162B and to the subband network 162C. The combiner 368C is coupled to the subband network 162C and to the subband network 162D. The neural network 170 provides the neural network output 161 to each of the combiner 368A, the combiner 368B, and the combiner 368C.

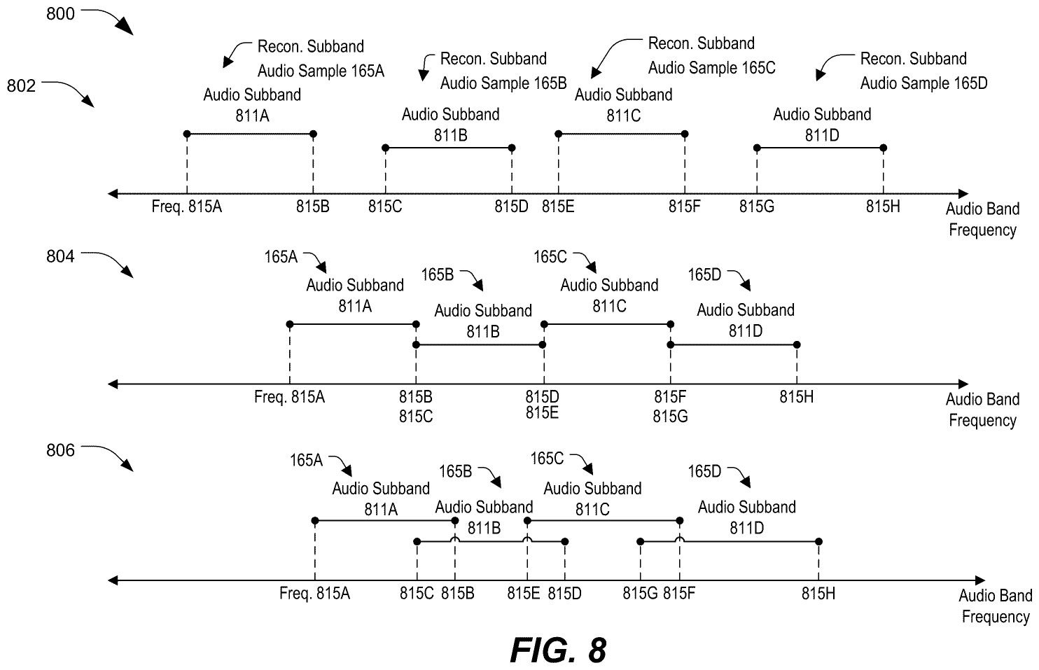

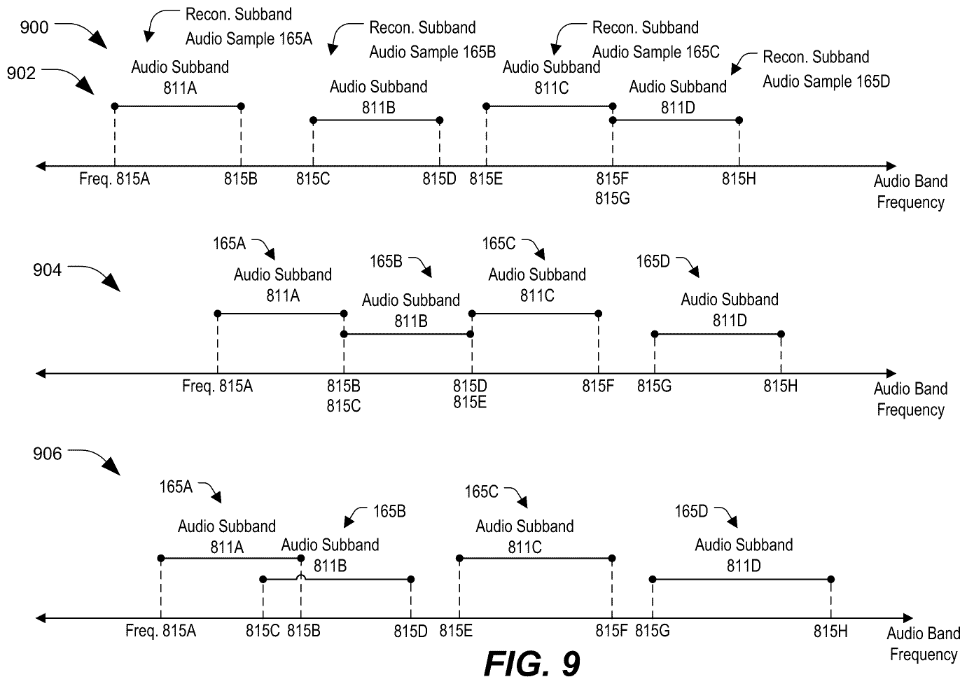

The subband networks 162 perform in a substantially similar manner as described with reference to FIG. 3. Each of the subband networks 162 generates a reconstructed subband audio sample of a reconstructed subband audio signal of the reconstructed audio signal 177. To illustrate, a first reconstructed subband audio signal of the reconstructed audio signal 177 corresponds to at least a first audio subband, a second reconstructed subband audio signal of the reconstructed audio signal 177 corresponds to at least a second audio subband, a third reconstructed subband audio signal of the reconstructed audio signal 177 corresponds to at least a third audio subband, a fourth reconstructed subband audio signal of the reconstructed audio signal 177 corresponds to at least a fourth audio subband, and so on. The first audio subband is associated with a first range of frequencies, the second audio subband is associated with a second range of frequencies, the third audio subband is associated with a third range of frequencies, and the fourth audio subband is associated with a fourth range of frequencies, as further described with reference to FIGS. 8-9.

For example, the subband network 162A generates a reconstructed subband audio sample 165A of a first reconstructed subband audio signal of the reconstructed audio signal 177. For example, the subband network 162A generates the reconstructed subband audio sample 165A based on the feature data 171, the previous subband audio sample 311A, the previous audio sample 371, predicted audio data (e.g., at least a portion of the predicted audio data 353), or a combination thereof, as further described with reference to FIGS. 5 and 6.

The combiner 368A combines the one or more subband neural network inputs 361A and the reconstructed subband audio sample 165A to generate one or more subband neural network inputs 361B. The subband network 162B generates a reconstructed subband audio sample 165B of a second reconstructed subband audio signal of the reconstructed audio signal 177. For example, the subband network 162B generates the reconstructed subband audio sample 165B based on the feature data 171, the previous subband audio sample 311A, the previous subband audio sample 311B, the previous audio sample 371, predicted audio data (e.g., at least a portion of the predicted audio data 353), the reconstructed subband audio sample 165A, or a combination thereof, as further described with reference to FIGS. 5 and 6.

The subband network 162B provides the reconstructed subband audio sample 165B to the combiner 368B. The combiner 368B combines the neural network output 161 and the reconstructed subband audio sample 165B to generate one or more subband neural network inputs 361C.

The subband network 162C processes the one or more subband neural network inputs 361C based at least in part on the feature data 171 to generate a reconstructed subband audio sample 165C of a third reconstructed subband audio signal of the reconstructed audio signal 177. For example, the subband network 162C generates the reconstructed subband audio sample 165C based on the feature data 171, the previous subband audio sample 311A, the previous subband audio sample 311B, a previous subband audio sample generated by the subband network 162C during a previous iteration, predicted audio data (e.g., at least a portion of the predicted audio data 353), the reconstructed subband audio sample 165A, the reconstructed subband audio sample 165B, or a combination thereof, as further described with reference to FIGS. 5 and 6.

The subband network 162C provides the reconstructed subband audio sample 165C to the combiner 368C. The combiner 368C combines the neural network output 161 and the reconstructed subband audio sample 165C to generate one or more subband neural network inputs 361D.

The subband network 162D processes the one or more subband neural network inputs 361D based at least in part on the feature data 171 to generate a reconstructed subband audio sample 165D of a fourth reconstructed subband audio signal of the reconstructed audio signal 177. For example, the subband network 162D generates the reconstructed subband audio sample 165D based on the feature data 171, the previous subband audio sample 311A, the previous subband audio sample 311B, the previous subband audio sample generated by the subband network 162C during a previous iteration, a previous subband audio sample 311D generated by the subband network 162D during the previous iteration, the predicted audio data (e.g., at least a portion of the predicted audio data 353), the reconstructed subband audio sample 165A, the reconstructed subband audio sample 165B, the reconstructed subband audio sample 165C, or a combination thereof, as further described with reference to FIGS. 5 and 6.

The reconstructor 166 combines reconstructed subband audio samples generated during one or more iterations by the subband networks 162 to generate a reconstructed audio sample 167. For example, the reconstructor 166 generates a reconstructed audio sample 167 by combining the reconstructed subband audio sample 165A, the reconstructed subband audio sample 165B, the reconstructed subband audio sample 165C, the reconstructed subband audio sample 165D, one or more additional reconstructed subband audio samples, or a combination thereof.

In a particular aspect, the subband networks 162, the reconstructor 166, or both, generate at least a portion of the one or more neural network inputs 151 for a subsequent iteration. For example, each of the subband networks 162 provides a reconstructed subband audio sample as a previous subband audio sample for a subsequent iteration. In a particular aspect, the reconstructor 166 provides the reconstructed audio sample 167 as a previous audio sample 371 for the subsequent iteration. In a particular implementation, each of the subband networks 162 provides at least a portion of the predicted audio data 353 for the subsequent iteration.

Although in the example shown in FIG. 4, the previous subband audio sample 311A from the subband network 162A and the previous subband audio sample 311D from the subband network 162D are provided as part of the neural network inputs 151 to the combiner 154, it is appreciated that in another example, the previous subband audio sample 311B from the subband network 162B and the previous subband audio sample from the subband network 162C are also provided as part of the neural network inputs 151.

The subband network 162A, the subband network 162B, the subband network 162C, and the subband network 162D are described as separate modules for ease of illustration. In a particular aspect, the same subband network generates multiple reconstructed audio samples one after the other. To illustrate, in some examples, the same subband network generates the reconstructed subband audio sample 165B subsequent to generating the reconstructed subband audio sample 165A. In some examples, the same subband network generates the reconstructed subband audio sample 165C subsequent to generating the reconstructed subband audio sample 165B. In some examples, the same subband network generates the reconstructed subband audio sample 165D subsequent to generating the reconstructed subband audio sample 165C.

In some examples, the reconstructor 166 can generate multiple reconstructed audio samples from the reconstructed subband audio sample 165A, the reconstructed subband audio sample 165B, the reconstructed subband audio sample 165C, the reconstructed subband audio sample 165D, one or more additional reconstructed audio samples, or a combination thereof. In an illustrative example, the reconstructor 166 includes a critically sampled 4-band filterbank. The audio signal 105 (e.g., s[n]) has a first sample rate (e.g., 16 kilohertz (kHz)) and is encoded as a first subband audio signal, a second subband audio signal, a third subband audio signal, and a fourth subband audio signal. In a particular aspect, the four subband audio signals are contiguous (e.g., adjacent and non-overlapping), and each of the four subband audio signals has a second sample rate (e.g., 4 kHz) that is one-fourth of the first sample rate (e.g., 16 kHz). The reconstructor 166 processes a first reconstructed subband audio signal from the subband network 162A (e.g., including the reconstructed subband audio sample 165A), a second reconstructed audio signal from the subband network 162B (e.g., including the reconstructed subband audio sample 165B), a third reconstructed subband audio signal from the subband network 162C (e.g., including the reconstructed subband audio sample 165C), and a fourth reconstructed audio signal from the subband network 162D (e.g., including the reconstructed subband audio sample 165D) that represent reconstructed versions of the first subband audio signal, the second subband audio signal, the third subband audio signal, and the fourth subband audio signal, respectively.

The reconstructor 166 upsamples and filters each of the first reconstructed subband audio signal, the second reconstructed audio signal, the third reconstructed audio signal, and the fourth reconstructed audio signal, and adds the resultant upsampled filtered signals to generate the reconstructed audio signal 177, which has four times the sample rate of the first reconstructed subband audio signal, the second reconstructed audio signal, the third reconstructed subband audio signal, and the fourth reconstructed audio signal. Thus, a frame of N reconstructed samples of the first reconstructed subband audio signal, a corresponding frame of N reconstructed samples of the second reconstructed subband audio signal, a corresponding frame of N reconstructed samples of the third reconstructed subband audio signal, and a corresponding frame of N reconstructed samples of the fourth reconstructed subband audio signal input to the reconstructor 166 results in an output of 4N reconstructed samples of the reconstructed audio signal 177. The reconstructor 166 can thus generate multiple reconstructed audio samples (e.g., four reconstructed audio samples) based on the reconstructed subband audio sample 165A, the reconstructed subband audio sample 165B, the reconstructed subband audio sample 165C, and the reconstructed subband audio sample 165D in each iteration.

Each of the subband network 162A, the subband network 162B, the subband network 162C, and the subband network 162D operates at a sample rate (e.g., 4 kHz) that is one-fourth of the first sample rate (e.g., 16 kHz) of the reconstructed audio signal 177. For example, each of the subband network 162A, the subband network 162B, the subband network 162C, and the subband network 162D generates data used to generate four reconstructed audio samples every four processing stages.

Referring to FIG. 5, a diagram of an illustrative implementation of a subband network 162 of the sample generation network 160 is shown. In a particular aspect, the subband network 162 represents an illustrative implementation of one or more of the subband network 162A, the subband network 162B, the subband network 162C, or the subband network 162D.

The subband network 162 includes a neural network 562 coupled to a linear prediction (LP) module 564. The neural network 562 includes one or more recurrent layers, a feedforward layer, a softmax layer 556, or a combination thereof. A recurrent layer includes a GRU, such as a GRU 552. The feed forward layer includes a fully connected layer, such as a FC layer 554.

The neural network 562 including one recurrent layer is provided as an illustrative example. In other examples, the neural network 562 can include multiple recurrent layers. A GRU of each previous recurrent layer of multiple recurrent layers is coupled to a GRU of a subsequent recurrent layer. The GRU 552 of a last recurrent layer of the one or more recurrent layers is coupled to the FC layer 554. The FC layer 554 is coupled to the softmax layer 556. In some implementations, the neural network 562 may include one or more additional layers, one or more additional connections, or a combination thereof, that are not shown for ease of illustration.

The one or more recurrent layers are configured to process one or more subband neural network inputs 361. In some implementations, a GRU (e.g., the GRU 552) of a first recurrent layer of the one or more recurrent layers determines a first hidden state based on a previous first hidden state and the one or more subband neural network inputs 361. The previous first hidden state is generated by the GRU (e.g., the GRU 552) of the first recurrent layer during a previous iteration.

In some implementations, the neural network 562 includes multiple recurrent layers. A GRU of each previous recurrent layer outputs a hidden state to a GRU of a subsequent recurrent layer of the multiple recurrent layers and the GRU of the subsequent recurrent layer generates a hidden state based on the received hidden state and a previous hidden state.

The GRU 552 of a last recurrent layer of the one or more recurrent layers outputs a first hidden state to the FC layer 554. The FC layer 554 is configured to process an output of the one or more recurrent layers. For example, the FC layer 554 includes a dual FC layer. Outputs of two fully-connected layers of the FC layer 554 are combined with an element-wise weighted sum to generate an output. The output of the FC layer 554 is provided to the softmax layer 556 to generate the probability distribution 557. In a particular aspect, the probability distribution 557 indicates probabilities of various values of residual data 563.

In some implementations, the one or more recurrent layers receive the embedding 155 (in addition to the neural network output 161) as the one or more subband neural network inputs 361. The output of the GRU 552, or the outputs of the GRUs of multiple recurrent layers, is provided to the FC layer 554. In some examples, the FC layer 554 (e.g., a dual-FC layer) can include two fully-connected layers combined with an element-wise weighted sum. Using the combined fully connected layers can enable computing a probability distribution 557 without significantly increasing the size of the preceding layer. In one illustrative example, the FC layer 554 can be defined as dual_fc(x)=a₁·tanh (W₁x)+a₂·tanh (W₂x), where W₁ and W₂ are weight matrices, a₁ and a₂ are weighting vectors, and tanh is the hyperbolic tangent function that generates a value between −1 and 1.

In some implementations, the output of the FC layer 554 is used with a softmax activation of the softmax layer 556 to compute the probability distribution 557 representing probabilities of possible excitation values for the residual data 563. The residual data 563 can be quantized (e.g., 8-bit mu-law quantized). An 8-bit quantized value corresponds to a count of possible values (e.g., 2⁸ or 256 values). The probability distribution 557 indicates a probability associated with each of the possible values (e.g., 256 values) of the residual data 563. In some implementations, the output of the FC layer 554 indicates mean values and a covariance matrix corresponding to the probability distribution 557 (e.g., a normal distribution) of the values of the residual data 563. In these implementations, the values of the residual data 563 can correspond to real-values (e.g., dequantized values).

The neural network 562 performs sampling 558 based on the probability distribution 557 to generate residual data 563. For example, the neural network 562 selects a particular value for the residual data 563 based on the probabilities indicated by the probability distribution 557. The neural network 562 provides the residual data 563 to the LP module 564.

The LP module 564 generates a reconstructed subband audio sample 165 based on the residual data 563. For example, the LP module 564 generates a reconstructed subband audio sample 165 of the reconstructed audio signal 177 based on the residual data 563, the feature data 171, predicted audio data 559, the previous audio sample 371, one or more reconstructed subband audio samples 565, or a combination thereof, as further described with reference to FIG. 6. In a particular aspect, the predicted audio data 559 corresponds to a portion of the predicted audio data 353 that is generated by the LP module 564 during a previous iteration, as further described with reference to FIG. 6.

In a particular aspect, the subband network 162 represents an illustrative implementation of the subband network 162A, the subband network 162B, the subband network 162C, or the subband network 162D. In this aspect, the one or more subband neural network inputs 361 represent the subband neural network inputs to the represented subband network and the reconstructed subband audio sample 165 represents the reconstructed subband audio sample output by the represented subband network. For example, in a particular aspect, the subband network 162 represents an illustrative implementation of the subband network 162A. In this aspect, the one or more subband neural network inputs 361 represent the one or more subband neural network inputs 361A and the reconstructed subband audio sample 165 represents the reconstructed subband audio sample 165A.

In a particular aspect, the subband network 162 represents an illustrative implementation of the subband network 162B. In this aspect, the one or more subband neural network inputs 361 represent the one or more subband neural network inputs 361B and the reconstructed subband audio sample 165 represents the reconstructed subband audio sample 165B. Similarly, in a particular aspect, the subband network 162 represents an illustrative implementation of the subband network 162C. In this aspect, the one or more subband neural network inputs 361 represent the one or more subband neural network inputs 361C and the reconstructed subband audio sample 165 represents the reconstructed subband audio sample 165C. In a particular aspect, the subband network 162 represents an illustrative implementation of the subband network 162D. In this aspect, the one or more subband neural network inputs 361 represent the one or more subband neural network inputs 361D and the reconstructed subband audio sample 165 represents the reconstructed subband audio sample 165D.

Each subband network 162 including the LP module 564 is provided as an illustrative example. In some implementations, each of the subband networks 162 (e.g., the subband network 162A, the subband network 162B, the subband network 162C, the subband network 162D, or a combination thereof) provides residual data to the reconstructor 166 of FIG. 1, the reconstructor 166 processes the residual data to generate reconstructed residual data, and provides the reconstructed residual data to an LP module. The LP module generates the reconstructed audio sample 167 based on the reconstructed residual data.

In a particular aspect, the reconstructor 166 receives first residual data 563 from the subband network 162A and second residual data 563 from the subband network 162B and processes the first residual data and the second residual data to generate reconstructed residual data. The LP module processes the reconstructed residual data based on the LPCs 141 and the feature data 171 to generate the reconstructed audio sample 167.

In another particular aspect, the reconstructor 166 receives first residual data 563 from the subband network 162A, second residual data 563 from the subband network 162B, third residual data 563 from the subband network 162C, and fourth residual data 563 from the subband network 162D. The reconstructor 166 processes the first residual data, the second residual data, the third residual data, and the fourth residual data to generate reconstructed residual data. The LP module processes the reconstructed residual data based on the LPCs 141 and the feature data 171 to generate the reconstructed audio sample 167.

Referring to FIG. 6, a diagram 600 of an illustrative implementation of the LP module 564 is shown. The LP module 564 includes a long-term prediction (LTP) engine 610 coupled to a short-term LP engine 630. The LTP engine 610 includes a LTP filter 612, and the short-term LP engine 630 includes a short-term LP filter 632.

In a particular aspect, the residual data 563 corresponds to an excitation signal, predicted audio data 657 and predicted audio data 659 correspond to a prediction, and the LP module 564 is configured to combine the excitation signal (e.g., the residual data 563) with the prediction (e.g., the predicted audio data 657 and the predicted audio data 659) to generate a reconstructed subband audio sample 165. For example, the LTP engine 610 combines the predicted audio data 657 with the residual data 563 to generate synthesized residual data 611 (e.g., LP residual data). The short-term LP engine 630 combines the synthesized residual data 611 with the predicted audio data 659 to generate the reconstructed subband audio sample 165. In a particular aspect, the predicted audio data 559 of FIG. 5 includes the predicted audio data 657 and the predicted audio data 659.

In some implementations, the LTP engine 610 combines the predicted audio data 657 with residual data associated with another audio sample to generate the synthesized residual data 611. For example, the LTP engine 610 combines the predicted audio data 657 with the residual data 563 and residual data 663 associated with one or more other subband audio samples to generate the synthesized residual data 611. In a particular implementation, the residual data 563 is generated by the neural network 562 of one of the subband networks 162 and the residual data 663 is generated by the neural network 562 of another one of the subband networks 162. For example, the residual data 563 is generated by the neural network 562 of the subband network 162A and the residual data 663 includes first residual data generated by the neural network 562 of the subband network 162B, second residual data generated by the neural network 562 of the subband network 162C, third residual data generated by the neural network 562 of the subband network 162D, or a combination thereof.

The LP module 564 is configured to generate a prediction for a subsequent iteration. For example, the LTP filter 612 generates next predicted audio data 667 (e.g., next long-term predicted data) based on the synthesized residual data 611, the pitch gain 173, the pitch estimation 175, or a combination thereof. In a particular aspect, the next predicted audio data 667 is used as the predicted audio data 657 in the subsequent iteration.

The short-term LP filter 632 generates next predicted audio data 669 (e.g., next short-term predicted data) based on the reconstructed subband audio sample 165, the LPCs 141, the previous audio sample 371, one or more reconstructed subband audio samples 665 received from LP modules of other subband networks, or a combination thereof. For example, the short-term LP filter 632 of the subband network 162A generates next predicted audio data 669 (e.g., next short-term predicted data) based on the reconstructed subband audio sample 165A, the LPCs 141, the previous audio sample 371, or a combination thereof. In this example, the short-term LP filter 632 does not receive any reconstructed subband audio samples 665 from LP modules of other subband networks, and the one or more reconstructed subband audio samples 565 of FIG. 5 include the reconstructed subband audio sample 165A.

In another example, the short-term LP filter 632 of the subband network 162B generates next predicted audio data 669 (e.g., next short-term predicted data) based on the reconstructed subband audio sample 165A received from the subband network 162A, the reconstructed subband audio sample 165B, the LPCs 141, the previous audio sample 371, or a combination thereof. In this example, the one or more reconstructed subband audio samples 665 include the reconstructed subband audio sample 165A, and the one or more reconstructed subband audio samples 565 of FIG. 5 include the reconstructed subband audio sample 165A, the reconstructed subband audio sample 165B, or both.

As a further example, the short-term LP filter 632 of the subband network 162C generates next predicted audio data 669 (e.g., next short-term predicted data) based on the reconstructed subband audio sample 165A received from the subband network 162A, the reconstructed subband audio sample 165B received from the subband network 162B, the reconstructed subband audio sample 165C, the LPCs 141, the previous audio sample 371, or a combination thereof. In this example, the one or more reconstructed subband audio samples 665 include the reconstructed subband audio sample 165A, the reconstructed subband audio sample 165B, or both, and the one or more reconstructed subband audio samples 565 of FIG. 5 include the reconstructed subband audio sample 165A, the reconstructed subband audio sample 165B, the reconstructed subband audio sample 165C, or a combination thereof.

In a particular aspect, the next predicted audio data 669 is used as the predicted audio data 659 in the subsequent iteration. In a particular aspect, the LP module 564 outputs the next predicted audio data 667, the next predicted audio data 669, or both, as a portion of the predicted audio data 353 for the subsequent iteration.

In a particular aspect, the LP module 564 outputs the reconstructed subband audio sample 165 as a previous subband audio sample (e.g., the previous subband audio sample 311A, the previous subband audio sample 311B, the previous subband audio sample generated by the subband network 162C during the previous iteration, or the previous subband audio sample 311D) in the neural network inputs 151 for the subsequent iteration. In a particular aspect, the LP module 564 outputs the residual data 563, the synthesized residual data 611, or both, as additional previous subband sample data in the neural network inputs 151 for the subsequent iteration.

In some implementations, the LPCs 141 include different LPCs associated with different audio subbands. For example, the LPCs 141 include first LPCs associated with the first audio subband and second LPCs associated with the second audio subband, where the second LPCs are distinct from the first LPCs. In these implementations, the short-term LP filter 632 of the subband network 162A generates the next predicted audio data 669 (e.g., next short-term predicted data) based on the first LPCs of the LPCs 141, the reconstructed subband audio sample 165A, the previous audio sample 371, or a combination thereof. The short-term LP filter 632 of the subband network 162B generates next predicted audio data 669 (e.g., next short-term predicted data) based on the second LPCs of the LPCs 141, the reconstructed subband audio sample 165A received from the subband network 162A, the reconstructed subband audio sample 165B, the previous audio sample 371, or a combination thereof.

The diagram 600 provides an illustrative non-limiting example of an implementation of the LP module 564 of the subband network 162 of FIG. 5. In other examples, the LP module 564 of the subband networks 162 can have various other implementations. For example, in a particular implementation, the residual data 563 is processed by the short-term LP engine 630 prior to processing of an output of the short-term LP engine 630 by the LTP engine 610. In this implementation, an output of the LTP engine 610 corresponds to the reconstructed subband audio sample 165. In some implementations, an LP module 564 includes a short-term LP engine 630, and does not include a LTP engine 610. For example, the residual data 563 is provided to the short-term LP engine 630, and the short-term LP engine 630 generates a reconstructed subband audio sample 165 based on the residual data 563 and the predicted audio data 659, independently of (e.g., without generating) synthesized residual data 611.

Referring to FIG. 7, a diagram 700 of illustrative examples of audio subbands corresponding to the reconstructed subband audio samples 165 is shown. In a particular aspect, the reconstructed subband audio samples 165 are generated by the sample generation network 160 of FIG. 1.

In a particular aspect, the reconstructed subband audio sample 165A of FIGS. 3-4 represents audio of an audio subband 711A. The audio subband 711A includes a first range of frequencies (e.g., a first frequency range) from a frequency 715A to a frequency 715B, where the frequency 715B is greater than (e.g., higher than) the frequency 715A. In a particular aspect, the reconstructed subband audio sample 165B represents audio of an audio subband 711B. The audio subband 711B includes a second range of frequencies (e.g., a second frequency range) from a frequency 715C to a frequency 715D, where the frequency 715D is greater than (e.g., higher than) the frequency 715C.

In an example 702, the first frequency range of the audio subband 711A and the second frequency range of the audio subband 711B are non-overlapping and non-consecutive. To illustrate, the frequency 715C is higher than the frequency 715B.

In an example 704, the first frequency range of the audio subband 711A and the second frequency range of the audio subband 711B are non-overlapping and consecutive. To illustrate, the frequency 715C is equal to the frequency 715B.

In an example 706, the first frequency range of the audio subband 711A at least partially overlaps the second frequency range of the audio subband 711B. To illustrate, the frequency 715C is greater than (e.g., higher than) the frequency 715A and less than (e.g., lower than) the frequency 715B.

The reconstructed subband audio sample 165A and the reconstructed subband audio sample 165B representing the audio subband 711A and the audio subband 711B, respectively, is provided as an illustrative example. In other examples, the reconstructed subband audio sample 165A and the reconstructed subband audio sample 165B can represent the audio subband 711B and the audio subband 711A, respectively.

The first frequency range of the audio subband 711A has a first width corresponding to a difference between the frequency 715A and the frequency 715B. The second frequency range of the audio subband 711B has a second width corresponding to a difference between the frequency 715C and the frequency 715D. In some examples, the first frequency range of the audio subband 711A has the same width as the second frequency range of the audio subband 711B. For example, the first width is equal to the second width. To illustrate, a difference between the frequency 715A and the frequency 715B is the same as a difference between the frequency 715C and the frequency 715D.

In some examples, the first frequency range of audio subband 711A is wider than the second frequency range of the audio subband 711B. For example, the first width is greater than the second width. To illustrate, a difference between the frequency 715A and the frequency 715B is greater than a difference between the frequency 715C and the frequency 715D. In some examples, the first frequency range of audio subband 711A is narrower than the second frequency range of the audio subband 711B. For example, the first width is less than the second width. To illustrate, a difference between the frequency 715A and the frequency 715B is less than a difference between the frequency 715C and the frequency 715D. In some examples, the first width is greater than or equal to the second width. To illustrate, a difference between the frequency 715A and the frequency 715B is greater than or equal to a difference between the frequency 715C and the frequency 715D.

Referring to FIG. 8, a diagram 800 of illustrative examples of audio subbands corresponding to the reconstructed subband audio samples 165 is shown. In a particular aspect, the reconstructed subband audio samples 165 are generated by the sample generation network 160 of FIG. 1.

An audio subband 811A includes a first frequency range from a frequency 815A to a frequency 815B, where the frequency 815B is greater than (e.g., higher than) the frequency 815A. An audio subband 811B includes a second frequency range from a frequency 815C to a frequency 815D, where the frequency 815D is greater than (e.g., higher than) the frequency 815C. An audio subband 811C includes a third frequency range from a frequency 815E to a frequency 815F, where the frequency 815F is greater than (e.g., higher than) the frequency 815E. An audio subband 811D includes a fourth frequency range from a frequency 815G to a frequency 815H, where the frequency 815H is greater than (e.g., higher than) the frequency 815G. Four audio subbands are shown as an illustrative example. In other examples, an audio band can be subdivided into fewer than four subbands or more than four subbands.

In a particular aspect, the reconstructed subband audio sample 165A of FIG. 4 represents the audio subband 811A, the reconstructed subband audio sample 165B represents the audio subband 811B, the reconstructed subband audio sample 165C represents the audio subband 811C, and the reconstructed subband audio sample 165D represents the audio subband 811D. The reconstructed subband audio sample 165A representing the audio subband 811A, the reconstructed subband audio sample 165B representing the audio subband 811B, the reconstructed subband audio sample 165C representing the audio subband 811C, and the reconstructed subband audio sample 165D representing the audio subband 811D is provided as an illustrative example. In other examples, any one of the reconstructed subband audio sample 165A, the reconstructed subband audio sample 165B, the reconstructed subband audio sample 165C, or the reconstructed subband audio sample 165D can represent audio of any one of the audio subband 811A, the audio subband 811B, the audio subband 811C, or the audio subband 811D.

In an example 802, the first frequency range of the audio subband 811A, the second frequency range of the audio subband 811B, the third frequency range of the audio subband 811C, and the fourth frequency range of the audio subband 811D are non-overlapping and non-consecutive. To illustrate, the frequency 815C is greater (e.g., higher) than the frequency 815B, the frequency 815E is greater (e.g., higher) than the frequency 815D, and the frequency 815G is greater (e.g., higher) than the frequency 815F.

In an example 804, the first frequency range of the audio subband 811A, the second frequency range of the audio subband 811B, the third frequency range of the audio subband 811C, and the fourth frequency range of the audio subband 811D are non-overlapping and consecutive. To illustrate, the frequency 815C is equal to the frequency 815B, the frequency 815E is equal to the frequency 815D, and the frequency 815G is equal to the frequency 815F.

In an example 806, the first frequency range of the audio subband 811A at least partially overlaps the second frequency range of the audio subband 811B, the second frequency range at least partially overlaps the third frequency range of the audio subband 811C, and the third frequency range at least partially overlaps the fourth frequency range of the audio subband 811D. To illustrate, the frequency 815C is greater than (e.g., higher than) the frequency 815A and less than (e.g., lower than) the frequency 815B, the frequency 815E is greater than (e.g., higher than) the frequency 815C and less than (e.g., lower than) the frequency 815D, and the frequency 815G is greater than (e.g., higher than) the frequency 815E and less than (e.g., lower than) the frequency 815F.

In some examples, each of the first frequency range of the audio subband 811A, the second frequency range of the audio subband 811B, the third frequency range of the audio subband 811C, and the fourth frequency range of the audio subband 811D has the same width. In other examples, at least one of the first frequency range, the second frequency range, the third frequency range, or the fourth frequency range is wider than at least another one of the first frequency range, the second frequency range, the third frequency range, or the fourth frequency range.

Referring to FIG. 9, a diagram 900 of illustrative examples of audio subbands corresponding to the reconstructed subband audio samples 165 are shown. In a particular aspect, the reconstructed subband audio samples 165 are generated by the sample generation network 160 of FIG. 1. An audio band can be divided into subbands that are a combination of non-overlapping, non-consecutive, consecutive, or partially overlapping frequency ranges.

In an example 902, the first frequency range of the audio subband 811A, the second frequency range of the audio subband 811B, the third frequency range of the audio subband 811C, and the fourth frequency range of the audio subband 811D are non-overlapping. The first frequency range of the audio subband 811A, the second frequency range of the audio subband 811B, and the third frequency range of the audio subband 811C are non-consecutive. To illustrate, the frequency 815C is greater (e.g., higher) than the frequency 815B, and the frequency 815E is greater (e.g., higher) than the frequency 815D. The third frequency range of the audio subband 811C and the fourth frequency range of the audio subband 811D are consecutive. For example, the frequency 815G is equal to the frequency 815F.

In an example 904, the first frequency range of the audio subband 811A, the second frequency range of the audio subband 811B, the third frequency range of the audio subband 811C, and the fourth frequency range of the audio subband 811D are non-overlapping. The first frequency range of the audio subband 811A is consecutive to the second frequency range of the audio subband 811B, and the second frequency range is consecutive to the third frequency range of the audio subband 811C. To illustrate, the frequency 815C is equal to the frequency 815B, and the frequency 815E is equal to the frequency 815D. The third frequency range of the audio subband 811C and the fourth frequency range of the audio subband 811D are non-consecutive. For example, the frequency 815G is greater than (e.g., higher than) the frequency 815F.

In an example 906, the first frequency range of the audio subband 811A at least partially overlaps the second frequency range of the audio subband 811B. To illustrate, the frequency 815C is greater than (e.g., higher than) the frequency 815A and less than (e.g., lower than) the frequency 815B. The second frequency range of the audio subband 811B, the third frequency range of the audio subband 811C, and the fourth frequency range of the audio subband 811D are non-overlapping and non-consecutive. To illustrate, the frequency 815E is greater than (e.g., higher than) the frequency 815D and the frequency 815G is greater than (e.g., higher than) the frequency 815F.

The diagram 900 provides some illustrative non-limiting examples of combinations of subbands with non-overlapping, non-consecutive, consecutive, or partially overlapping frequency ranges. An audio band can include various other combinations of subbands with non-overlapping, non-consecutive, consecutive, or partially overlapping frequency ranges.

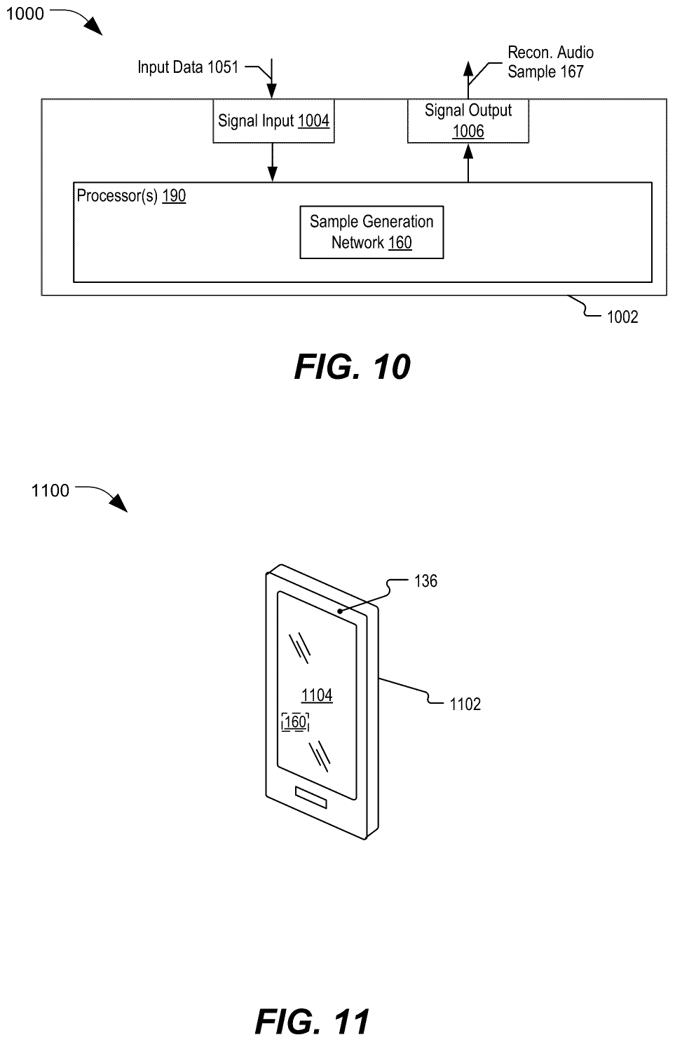

FIG. 10 depicts an implementation 1000 of the device 102 as an integrated circuit 1002 that includes the one or more processors 190. The one or more processors 190 include the sample generation network 160. The integrated circuit 1002 also includes a signal input 1004, such as one or more bus interfaces, to enable input data 1051 to be received for processing. For example, the input data 1051 includes at least a part of the one or more neural network inputs 151, the pitch gain 173, the pitch estimation 175, the LPCs 141, the feature data 171 of FIG. 1, the encoded audio data 241, the features 243, the features 253, the conditioning vector 251 of FIG. 2, or a combination thereof. The integrated circuit 1002 also includes a signal output 1006, such as a bus interface, to enable sending of an output signal, such as the reconstructed audio sample 167, the reconstructed audio signal 177, or a combination thereof. The integrated circuit 1002 enables implementation of performing audio sample reconstruction using a neural network and multiple subband networks as a component in a system, such as a mobile phone or tablet as depicted in FIG. 11, a headset as depicted in FIG. 12, a wearable electronic device as depicted in FIG. 13, a voice-controlled speaker system as depicted in FIG. 14, a camera as depicted in FIG. 15, a virtual reality, mixed reality, or augmented reality headset as depicted in FIG. 16, or a vehicle as depicted in FIG. 17 or FIG. 18.

FIG. 11 depicts an implementation 1100 in which the device 102 includes a mobile device 1102, such as a phone or tablet, as illustrative, non-limiting examples. The mobile device 1102 includes a display screen 1104. Components of the one or more processors 190, including the sample generation network 160, are integrated in the mobile device 1102 and are illustrated using dashed lines to indicate internal components that are not generally visible to a user of the mobile device 1102. In a particular example, the sample generation network 160 operates to perform audio sample reconstruction to generate the reconstructed audio sample 167 (e.g., the reconstructed audio signal 177), which is then processed to perform one or more operations at the mobile device 1102, such as to launch a graphical user interface or otherwise display other information associated with speech detected in the reconstructed audio signal 177 at the display screen 1104 (e.g., via an integrated “smart assistant” application).

FIG. 12 depicts an implementation 1200 in which the device 102 includes a headset device 1202. Components of the one or more processors 190, including the sample generation network 160, are integrated in the headset device 1202. In a particular example, the sample generation network 160 operates to generate the reconstructed audio sample 167 (e.g., the reconstructed audio signal 177), which may cause the headset device 1202 to output the reconstructed audio signal 177 via one or more speakers 136, to perform one or more operations at the headset device 1202, to transmit audio data corresponding to voice activity detected in the reconstructed audio signal 177 to a second device (not shown), for further processing, or a combination thereof.

FIG. 13 depicts an implementation 1300 in which the device 102 includes a wearable electronic device 1302, illustrated as a “smart watch.” The sample generation network 160 is integrated into the wearable electronic device 1302. In a particular example, the sample generation network 160 operates to generate the reconstructed audio sample 167 (e.g., the reconstructed audio signal 177). In some implementations, the wearable electronic device 1302 outputs the reconstructed audio signal 177 via one or more speakers 136. In some implementations, the reconstructed audio sample 167 is processed to perform one or more operations at the wearable electronic device 1302, such as to launch a graphical user interface or otherwise display other information (e.g., a song title, an artist name, etc.) associated with audio detected in the reconstructed audio signal 177 at a display screen 1304 of the wearable electronic device 1302. To illustrate, the wearable electronic device 1302 may include a display screen that is configured to display a notification based on the audio detected by the wearable electronic device 1302. In a particular example, the wearable electronic device 1302 includes a haptic device that provides a haptic notification (e.g., vibrates) in response to detection of audio. For example, the haptic notification can cause a user to look at the wearable electronic device 1302 to see a displayed notification indicating information (e.g., a song title, an artist name, etc.) associated with the audio.

FIG. 14 is an implementation 1400 in which the device 102 includes a wireless speaker and voice activated device 1402. The wireless speaker and voice activated device 1402 can have wireless network connectivity and is configured to execute an assistant operation. The one or more processors 190 including the sample generation network 160 are included in the wireless speaker and voice activated device 1402. The wireless speaker and voice activated device 1402 also includes the one or more speakers 136. During operation, the wireless speaker and voice activated device 1402 outputs, via the one or more speakers 136, the reconstructed audio signal 177 generated via operation of the sample generation network 160. In some implementations, in response to a verbal command identified as user speech in the reconstructed audio signal 177, the wireless speaker and voice activated device 1402 can execute assistant operations, such as via execution of an integrated assistant application. The assistant operations can include adjusting a temperature, playing music, turning on lights, etc. For example, the assistant operations are performed responsive to detecting a command after a keyword or key phrase (e.g., “hello assistant”).

FIG. 15 depicts an implementation 1500 in which the device 102 includes a portable electronic device that corresponds to a camera device 1502. The sample generation network 160 is included in the camera device 1502. During operation, the camera device 1502 outputs, via one or more speakers 136, the reconstructed audio signal 177 generated via operation of the sample generation network 160. In some implementations, in response to detecting a verbal command identified in the reconstructed audio signal 177, the camera device 1502 can execute operations responsive to verbal commands, such as to adjust image or video capture settings, image or video playback settings, or image or video capture instructions, as illustrative examples.

FIG. 16 depicts an implementation 1600 in which the device 102 includes a portable electronic device that corresponds to a virtual reality, mixed reality, or augmented reality headset 1602. The sample generation network 160 is integrated into the headset 1602. In a particular aspect, the headset 1602 outputs, via one or more speakers 136, the reconstructed audio signal 177 generated via operation of the sample generation network 160. In some implementations, voice activity detection can be performed based on the reconstructed audio signal 177. A visual interface device is positioned in front of the user's eyes to enable display of augmented reality, mixed reality, or virtual reality images or scenes to the user while the headset 1602 is worn. In a particular example, the visual interface device is configured to display a notification indicating audio detected in the reconstructed audio signal 177.

FIG. 17 depicts an implementation 1700 in which the device 102 corresponds to, or is integrated within, a vehicle 1702, illustrated as a manned or unmanned aerial device (e.g., a package delivery drone). The sample generation network 160 is integrated into the vehicle 1702. The vehicle 1702 outputs, via one or more speakers 136, the reconstructed audio signal 177 generated via operation of the sample generation network 160, such as for assembly instructions or installation instructions for a package recipient.

FIG. 18 depicts another implementation 1800 in which the device 102 corresponds to, or is integrated within, a vehicle 1802, illustrated as a car. The vehicle 1802 includes the one or more processors 190 including the sample generation network 160. Speech recognition can be performed based on the reconstructed audio signal 177 generated via operation of the sample generation network 160. In a particular implementation, the vehicle 1802 outputs, via one or more speakers 136, the reconstructed audio signal 177 generated via operation of the sample generation network 160. For example, the reconstructed audio signal 177 corresponds to an audio signal received during a phone call with another device. In another example, the reconstructed audio signal 177 corresponds to an audio signal output by an entertainment system of the vehicle 1802. In some examples, the vehicle 1802 provides, via a display 1820, information (e.g., caller identification, song title, etc.) associated with the reconstructed audio signal 177.

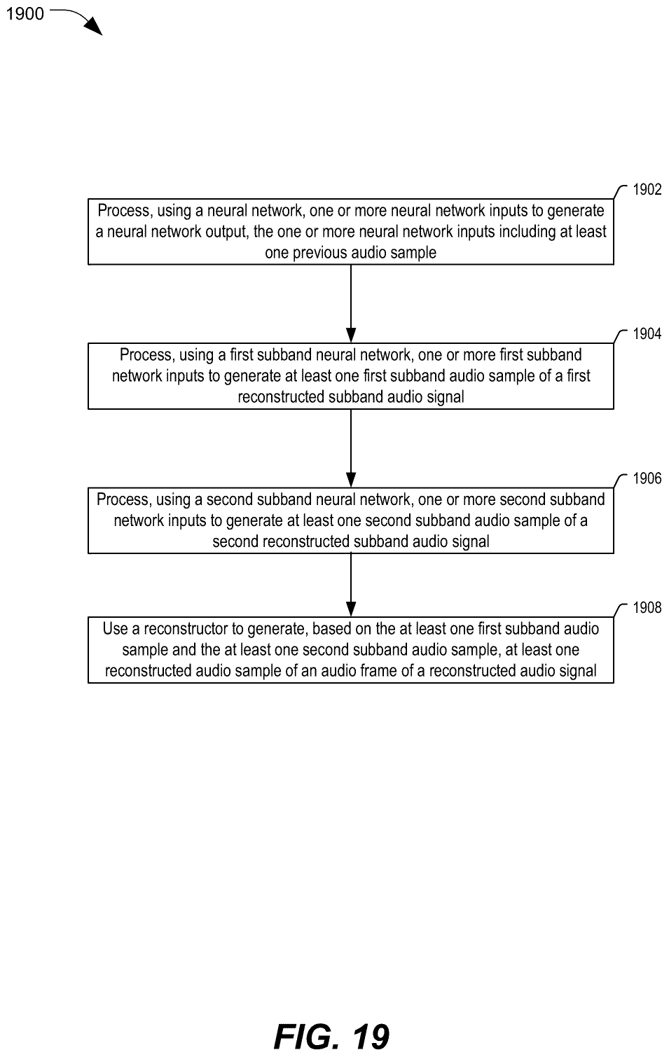

Referring to FIG. 19, a particular implementation of a method 1900 of performing audio sample reconstruction using a neural network and multiple subband networks is shown. In a particular aspect, one or more operations of the method 1900 are performed by at least one of the neural network 170, the subband networks 162, the reconstructor 166, the sample generation network 160, the audio synthesizer 150, the one or more processors 190, the device 102, the system 100 of FIG. 1, the system 200 of FIG. 2, or a combination thereof.

The method 1900 includes processing, using a neural network, one or more neural network inputs to generate a neural network output, the one or more neural network inputs including at least one previous audio sample, at 1902. For example, the sample generation network 160 uses the neural network 170 to process the embedding 155 that is based on the one or more neural network inputs 151 to generate the neural network output 161, as described with reference to FIG. 1. The one or more neural network inputs 151 includes at least the previous subband audio sample 311A, the previous subband audio sample 311B, the previous audio sample 371, or a combination thereof, as described with reference to FIG. 3.

The method 1900 also includes processing, using a first subband neural network, one or more first subband network inputs to generate at least one first subband audio sample of a first reconstructed subband audio signal, at 1904. For example, the sample generation network 160 uses the subband network 162A to process the one or more subband neural network inputs 361A to generate at least the reconstructed subband audio sample 165A of a first reconstructed subband audio signal, as described with reference to FIG. 3. In a particular aspect, the one or more subband neural network inputs 361A include the previous audio sample 371, the previous subband audio sample 311A, the previous subband audio sample 311B, the neural network output 161, or a combination thereof.

The method 1900 further includes processing, using a second subband neural network, one or more second subband network inputs to generate at least one second subband audio sample of a second reconstructed subband audio signal, at 1906. For example, the sample generation network 160 uses the subband network 162B to process the one or more subband neural network inputs 361B to generate at least the reconstructed subband audio sample 165B of a second reconstructed subband audio signal, as described with reference to FIG. 3. In a particular aspect, the one or more subband neural network inputs 361B include the previous subband audio sample 311B, the previous audio sample 371, the reconstructed subband audio sample 165A, the previous subband audio sample 311A, the neural network output 161, or a combination thereof.

The method 1900 also includes use a reconstructor to generate, based on the at least one first subband audio sample and the at least one second subband audio sample, at least one reconstructed audio sample of an audio frame of a reconstructed audio signal, at 1908. For example, the sample generation network 160 uses the reconstructor 166 to generate, based on the reconstructed subband audio sample 165A and the reconstructed subband audio sample 165B, at least the reconstructed audio sample 167 of the reconstructed audio frame 153A of the reconstructed audio signal 177, as described with reference to FIG. 3.

The method 1900 thus enables generation of the reconstructed audio sample 167 using the neural network 170, the subband networks 162 (e.g., the subband network 162A and the subband network 162B) and the reconstructor 166. Using the neural network 170 as an initial stage of neural network processing reduces complexity, thereby reducing processing time, memory usage, or both. Having separate subband networks takes account of any dependencies between audio subbands so as to deal with the conditioning across bands.

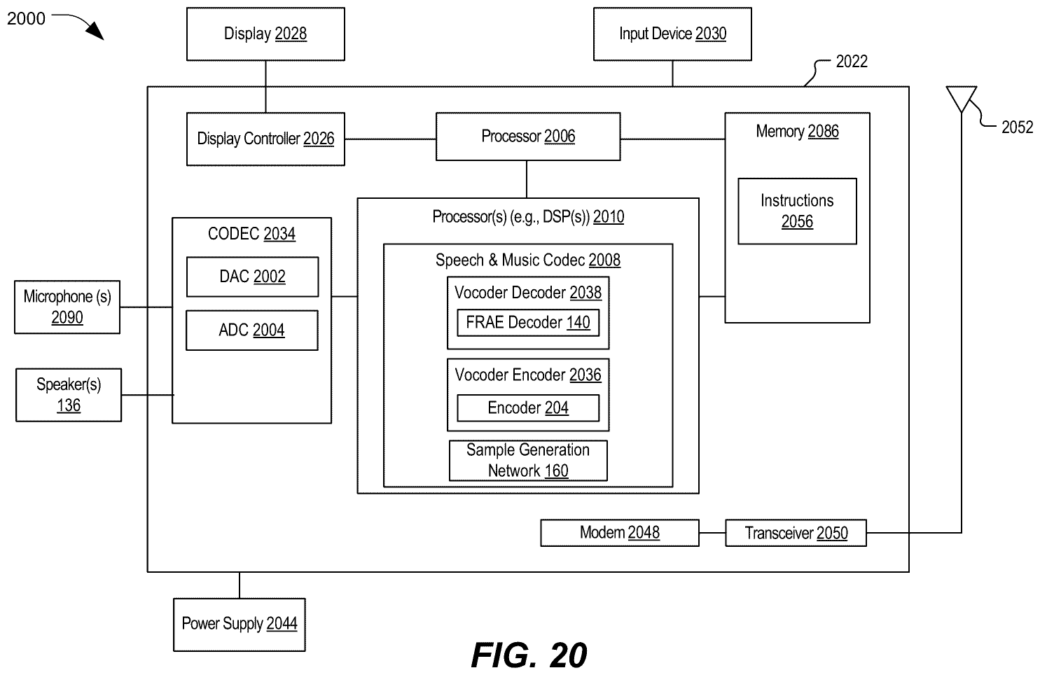

The method 1900 of FIG. 19 may be implemented by a field-programmable gate array (FPGA) device, an application-specific integrated circuit (ASIC), a processing unit such as a central processing unit (CPU), a DSP, a graphics processing unit (GPU), a controller, another hardware device, firmware device, or any combination thereof. As an example, the method 1900 of FIG. 19 may be performed by a processor that executes instructions, such as described with reference to FIG. 20.

Referring to FIG. 20, a block diagram of a particular illustrative implementation of a device is depicted and generally designated 2000. In various implementations, the device 2000 may have more or fewer components than illustrated in FIG. 20. In an illustrative implementation, the device 2000 may correspond to the device 102. In an illustrative implementation, the device 2000 may perform one or more operations described with reference to FIGS. 1-19.

In a particular implementation, the device 2000 includes a processor 2006 (e.g., a CPU). The device 2000 may include one or more additional processors 2010 (e.g., one or more DSPs, one or more GPUs, or a combination thereof). In a particular aspect, the one or more processors 190 of FIG. 1 corresponds to the processor 2006, the processors 2010, or a combination thereof. The processors 2010 may include a speech and music coder-decoder (CODEC) 2008 that includes a voice coder (“vocoder”) encoder 2036, a vocoder decoder 2038, or a combination thereof. In a particular aspect, the processors 2010 may include the sample generation network 160. In a particular aspect, the vocoder encoder 2036 may include the encoder 204. In a particular aspect, the vocoder decoder 2038 may include the FRAE decoder 140.

The device 2000 may include a memory 2086 and a CODEC 2034. The memory 2086 may include instructions 2056, that are executable by the one or more additional processors 2010 (or the processor 2006) to implement the functionality described with reference to the sample generation network 160. The device 2000 may include a modem 2048 coupled, via a transceiver 2050, to an antenna 2052. In a particular aspect, the modem 2048 may correspond to the modem 206, the modem 240 of FIG. 2, or both. In a particular aspect, the transceiver 2050 may include the transmitter 208, the receiver 238 of FIG. 2, or both.

The device 2000 may include a display 2028 coupled to a display controller 2026. The one or more speakers 136, one or more microphones 2090, or a combination thereof, may be coupled to the CODEC 2034. The CODEC 2034 may include a digital-to-analog converter (DAC) 2002, an analog-to-digital converter (ADC) 2004, or both. In a particular implementation, the CODEC 2034 may receive analog signals from the one or more microphones 2090, convert the analog signals to digital signals using the analog-to-digital converter 2004, and provide the digital signals to the speech and music codec 2008. In a particular implementation, the speech and music codec 2008 may provide digital signals to the CODEC 2034. For example, the speech and music codec 2008 may provide the reconstructed audio signal 177 generated by the sample generation network 160 to the CODEC 2034. The CODEC 2034 may convert the digital signals to analog signals using the digital-to-analog converter 2002 and may provide the analog signals to the one or more speakers 136.

In a particular implementation, the device 2000 may be included in a system-in-package or system-on-chip device 2022. In a particular implementation, the memory 2086, the processor 2006, the processors 2010, the display controller 2026, the CODEC 2034, and the modem 2048 are included in the system-in-package or system-on-chip device 2022. In a particular implementation, an input device 2030 and a power supply 2044 are coupled to the system-in-package or the system-on-chip device 2022. Moreover, in a particular implementation, as illustrated in FIG. 20, the display 2028, the input device 2030, the one or more speakers 136, the one or more microphones 2090, the antenna 2052, and the power supply 2044 are external to the system-in-package or the system-on-chip device 2022. In a particular implementation, each of the display 2028, the input device 2030, the one or more speakers 136, the one or more microphones 2090, the antenna 2052, and the power supply 2044 may be coupled to a component of the system-in-package or the system-on-chip device 2022, such as an interface or a controller.

The device 2000 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of- things (IoT) device, a virtual reality (VR) device, a base station, a mobile device, or any combination thereof.

In conjunction with the described implementations, an apparatus includes means for processing, using a neural network, one or more neural network inputs to generate a neural network output, the one or more neural network inputs including at least one previous audio sample. For example, the means for processing one or more neural network inputs can correspond to the neural network 170, the sample generation network 160, the audio synthesizer 150, the one or more processors 190, the device 102, the system 100 of FIG. 1, the system 200 of FIG. 2, the processor 2006, the one or more processors 2010, one or more other circuits or components configured to process one or more neural network inputs to generate a neural network output, or any combination thereof. In a particular aspect, the at least one previous audio sample includes the previous subband audio sample 311A, the previous subband audio sample 311B, the previous audio sample 371, or a combination thereof.

The apparatus also includes means for processing, using a first subband neural network, one or more first subband network inputs to generate at least one first subband audio sample of a first reconstructed subband audio signal. For example, the means for processing one or more first subband network inputs can correspond to the subband network 162A, the subband networks 162, the neural network 170, the sample generation network 160, the audio synthesizer 150, the one or more processors 190, the device 102, the system 100 of FIG. 1, the system 200 of FIG. 2, the processor 2006, the one or more processors 2010, one or more other circuits or components configured to process one or more first subband network inputs using a first subband neural network to generate at least one first subband audio sample, or any combination thereof.

In a particular aspect, the one or more first subband network inputs correspond to the one or more subband neural network inputs 361A. The one or more subband neural network inputs 361A include the previous audio sample 371, the previous subband audio sample 311A, the previous subband audio sample 311B, the neural network output 161, or a combination thereof. In a particular aspect, the first reconstructed subband audio signal corresponds to the audio subband 711A.

The apparatus further includes means for processing, using a second subband neural network, one or more second subband network inputs to generate at least one second subband audio sample of a second reconstructed subband audio signal. For example, the means for processing one or more second subband network inputs can correspond to the subband network 162B, the subband networks 162, the neural network 170, the sample generation network 160, the audio synthesizer 150, the one or more processors 190, the device 102, the system 100 of FIG. 1, the system 200 of FIG. 2, the processor 2006, the one or more processors 2010, one or more other circuits or components configured to process one or more second subband network inputs using a second subband neural network to generate at least one second subband audio sample, or any combination thereof.

In a particular aspect, the one or more second subband network inputs correspond to the one or more subband neural network inputs 361B. The one or more subband neural network inputs 361B include the previous subband audio sample 311B, the previous audio sample 371, the reconstructed subband audio sample 165A, the previous subband audio sample 311A, the neural network output 161, or a combination thereof. In a particular aspect, the second reconstructed subband audio signal corresponds to the audio subband 711B.

The apparatus also includes means for generating, based on the at least one first subband audio sample and the at least one second subband audio sample, at least one reconstructed audio sample of an audio frame of a reconstructed audio signal. For example, the means for generating at least one reconstructed audio sample can correspond to the reconstructor 166, the neural network 170, the sample generation network 160, the audio synthesizer 150, the one or more processors 190, the device 102, the system 100 of FIG. 1, the system 200 of FIG. 2, the processor 2006, the one or more processors 2010, one or more other circuits or components configured to generate at least one reconstructed audio sample based on at least one first subband audio sample and at least one second subband audio sample, or any combination thereof.

In some implementations, a non-transitory computer-readable medium (e.g., a computer-readable storage device, such as the memory 2086) includes instructions (e.g., the instructions 2056) that, when executed by one or more processors (e.g., the one or more processors 2010 or the processor 2006), cause the one or more processors to process, using a neural network (e.g., the neural network 170), one or more neural network inputs (e.g., the one or more neural network inputs 151 as represented by the embedding 155) to generate a neural network output (e.g., the neural network output 161), the one or more neural network inputs including at least one previous audio sample (e.g., the previous subband audio sample 311A, the previous subband audio sample 311B, the previous audio sample 371, or a combination thereof).

The instructions, when executed by the one or more processors, also cause the one or more processors to process, using a first subband neural network (e.g., the subband network 162A), one or more first subband network inputs (e.g., the one or more subband neural network inputs 361A) to generate at least one first subband audio sample (e.g., the reconstructed subband audio sample 165A) of a first reconstructed subband audio signal. The one or more first subband network inputs include at least the neural network output. The first reconstructed subband audio signal corresponds to a first audio subband (e.g., the audio subband 711A). The instructions, when executed by the one or more processors, further cause the one or more processors to process, using a second subband neural network (e.g., the subband network 162B), one or more second subband network inputs (e.g., the one or more subband neural network inputs 361B) to generate at least one second subband audio sample (e.g., the reconstructed subband audio sample 165B) of a second reconstructed subband audio signal. The one or more second subband network inputs include at least the neural network output. The second reconstructed subband audio signal corresponds to a second audio subband (e.g., 711B) that is distinct from the first audio subband.

The instructions, when executed by the one or more processors, further cause the one or more processors to generate, based on the at least one first subband audio sample and the at least one second subband audio sample, at least one reconstructed audio sample (e.g., the reconstructed audio sample 167) of an audio frame (e.g., the reconstructed audio frame 153A) of a reconstructed audio signal (e.g., the reconstructed audio signal 177).

The at least one previous audio sample includes at least one previous first subband audio sample (e.g., the previous subband audio sample 311A) of the first reconstructed subband audio signal, at least one previous second subband audio sample (e.g., the previous subband audio sample 311B) of the second reconstructed subband audio signal, at least one previous reconstructed audio sample (e.g., the previous audio sample 371) of the reconstructed audio signal, or a combination thereof.

Particular aspects of the disclosure are described below in interrelated examples:

According to Example 1, a device includes: a neural network configured to process one or more neural network inputs to generate a neural network output, the one or more neural network inputs including at least one previous audio sample; a first subband neural network configured to process one or more first subband network inputs to generate at least one first subband audio sample of a first reconstructed subband audio signal, the one or more first subband network inputs including at least the neural network output, wherein the first reconstructed subband audio signal corresponds to a first audio subband; a second subband neural network configured to process one or more second subband network inputs to generate at least one second subband audio sample of a second reconstructed subband audio signal, the one or more second subband network inputs including at least the neural network output, wherein the second reconstructed subband audio signal corresponds to a second audio subband that is distinct from the first audio subband; and a reconstructor configured to generate, based on the at least one first subband audio sample and the at least one second subband audio sample, at least one reconstructed audio sample of an audio frame of a reconstructed audio signal, wherein the at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

Example 2 includes the device of Example 1, wherein the reconstructor is configured to generate multiple reconstructed audio samples of the reconstructed audio signal per inference of the neural network, wherein the first subband neural network operates at a sample rate of the reconstructed audio signal, and wherein the second subband neural network operates at the sample rate of the reconstructed audio signal.

Example 3 includes the device of Example 1 or Example 2, wherein the one or more first subband network inputs to the first subband neural network further include the at least one previous first subband audio sample, the at least one previous second subband audio sample, the at least one previous reconstructed audio sample, or a combination thereof, and wherein the one or more second subband network inputs to the second subband neural network further include the at least one first subband audio sample, the at least one previous second subband audio sample, the at least one previous reconstructed audio sample, the at least one previous first subband audio sample, or a combination thereof.

Example 4 includes the device of any of Example 1 to Example 3, further including one or more additional subband neural networks configured to generate at least one additional subband audio sample of one or more additional subband audio signals, wherein the at least one reconstructed audio sample is further based on the at least one additional subband audio sample.

Example 5 includes the device of any of Example 1 to Example 4, further including: a third subband neural network configured to process one or more third subband network inputs to generate at least one third subband audio sample of a third reconstructed subband audio signal; and a fourth subband neural network configured to process one or more fourth subband network inputs to generate at least one fourth subband audio sample of a fourth reconstructed subband audio signal, wherein the at least one reconstructed audio sample is further based on the at least one third subband audio sample, the at least one fourth subband audio sample, or a combination thereof.

Example 6 includes the device of Example 5, wherein the one or more third subband network inputs to the third subband neural network include the at least one second subband audio sample and the neural network output, and wherein the one or more fourth subband network inputs to the fourth subband neural network include the at least one third subband audio sample and the neural network output.

Example 7 includes the device of Example 5 or Example 6, wherein the third reconstructed subband audio signal corresponds to a third audio subband, and the fourth reconstructed subband audio signal corresponds to a fourth audio subband, wherein the third audio subband is distinct from the first audio subband and the second audio subband, and wherein the fourth audio subband is distinct from the first audio subband, the second audio subband, and the third audio subband.

Example 8 includes the device of any of Example 1 to Example 7, wherein a first particular audio subband corresponds to a first range of frequencies, wherein a second particular audio subband corresponds to a second range of frequencies, and wherein the first particular audio subband includes one of the first audio subband, the second audio subband, a third audio subband, or a fourth audio subband, and wherein the second particular audio subband includes another one of the first audio subband, the second audio subband, the third audio subband, or the fourth audio subband.

Example 9 includes the device of Example 8, wherein the first range of frequencies has a first width that is greater than or equal to a second width of the second range of frequencies.

Example 10 includes the device of Example 8 or Example 9, wherein the first range of frequencies at least partially overlaps the second range of frequencies.

Example 11 includes the device of Example 8 or Example 9, wherein the first range of frequencies is adjacent to the second range of frequencies.

Example 12 includes the device of any of Example 1 to Example 11, wherein a recurrent layer of the neural network includes a gated recurrent unit (GRU).

Example 13 includes the device of any of Example 1 to Example 12, wherein the one or more neural network inputs also include predicted audio data.

Example 14 includes the device of Example 13, wherein the predicted audio data includes long-term prediction (LTP) data, linear prediction (LP) data, or a combination thereof.

Example 15 includes the device of any of Example 1 to Example 14, wherein the one or more neural network inputs also include linear prediction (LP) prediction of at least one subband audio sample, LP residual of at least one previous subband audio sample, the at least one previous subband audio sample, the at least one previous reconstructed audio sample, or a combination thereof.

Example 16 includes the device of any of Example 1 to Example 15, wherein the first subband neural network includes a first neural network that is configured to process the one or more first subband network inputs to generate first residual data.

Example 17 includes the device of Example 16, wherein the first subband neural network further includes a first linear prediction (LP) filter configured to process the first residual data based on linear predictive coefficients (LPCs) to generate the at least one first subband audio sample.

Example 18 includes the device of Example 17, wherein the first LP filter includes a long-term prediction (LTP) filter, a short-term LP filter, or both.

Example 19 includes the device of Example 17 or Example 18, further including: a modem configured to receive encoded audio data from a second device; and a decoder configured to: decode the encoded audio data to generate feature data of the audio frame; and estimate the LPCs based on the feature data.

Example 20 includes the device of Example 17 or Example 18, further including: a modem configured to receive encoded audio data from a second device; and a decoder configured to decode the encoded audio data to generate the LPCs.

Example 21 includes the device of any of Example 1 to Example 20, wherein the one or more second subband network inputs also include linear prediction (LP) prediction of at least one subband audio sample, LP residual of at least one previous subband audio sample, the at least one previous subband audio sample, the at least one previous reconstructed audio sample, LP residual of the at least one first subband audio sample, the at least one first subband audio sample, or a combination thereof.

Example 22 includes the device of any of Example 1 to Example 21, wherein the one or more first subband network inputs also include linear prediction (LP) prediction of at least one subband audio sample, LP residual of at least one previous subband audio sample, the at least one previous subband audio sample, the at least one previous reconstructed audio sample, or a combination thereof.

Example 23 includes the device of any of Example 1 to Example 22, wherein the reconstructor is further configured to provide the audio frame to a speaker.

Example 24 includes the device of any of Example 1 to Example 23, wherein the reconstructor includes a subband reconstruction filterbank.

Example 25 includes the device of any of Example 1 to Example 24, wherein the at least one reconstructed audio sample includes a plurality of audio samples.

Example 26 includes the device of any of Example 1 to Example 25, wherein the reconstructed audio signal includes a reconstructed speech signal.

According to Example 27, a method includes: processing, using a neural network, one or more neural network inputs to generate a neural network output, the one or more neural network inputs including at least one previous audio sample; processing, using a first subband neural network, one or more first subband network inputs to generate at least one first subband audio sample of a first reconstructed subband audio signal, the one or more first subband network inputs including at least the neural network output, wherein the first reconstructed subband audio signal corresponds to a first audio subband; processing, using a second subband neural network, one or more second subband network inputs to generate at least one second subband audio sample of a second reconstructed subband audio signal, the one or more second subband network inputs including at least the neural network output, wherein the second reconstructed subband audio signal corresponds to a second audio subband that is distinct from the first audio subband; and using a reconstructor to generate, based on the at least one first subband audio sample and the at least one second subband audio sample, at least one reconstructed audio sample of an audio frame of a reconstructed audio signal, wherein the at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

Example 28 includes the method of Example 27, further comprising using the reconstructor to generate multiple reconstructed audio samples of the reconstructed audio signal per inference of the neural network, wherein the first subband neural network operates at a sample rate of the reconstructed audio signal, and wherein the second subband neural network operates at the sample rate of the reconstructed audio signal.

Example 29 includes the method of Example 27 or Example 28, wherein the one or more first subband network inputs to the first subband neural network further include the at least one previous first subband audio sample, the at least one previous second subband audio sample, the at least one previous reconstructed audio sample, or a combination thereof.

Example 30 includes the method of any of Example 27 to Example 29, wherein the one or more second subband network inputs to the second subband neural network further include the at least one first subband audio sample, the at least one previous second subband audio sample, the at least one previous reconstructed audio sample, the at least one previous first subband audio sample, or a combination thereof.

Example 31 includes the method of any of Example 26 to Example 30, further including generating, using one or more additional subband neural networks, at least one additional subband audio sample of one or more additional subband audio signals, wherein the at least one reconstructed audio sample is further based on the at least one additional subband audio sample.

Example 32 includes the method of any of Example 27 to Example 31, further including: processing, using a third subband neural network, one or more third subband network inputs to generate at least one third subband audio sample of a third reconstructed subband audio signal; and processing, using a fourth subband neural network, one or more fourth subband network inputs to generate at least one fourth subband audio sample of a fourth reconstructed subband audio signal, wherein the at least one reconstructed audio sample is further based on the at least one third subband audio sample, the at least one fourth subband audio sample, or a combination thereof.

Example 33 includes the method of Example 32, wherein the one or more third subband network inputs to the third subband neural network include the at least one second subband audio sample and the neural network output, and wherein the one or more fourth subband network inputs to the fourth subband neural network include the at least one third subband audio sample and the neural network output.

Example 34 includes the method of Example 32 or Example 33, wherein the third reconstructed subband audio signal corresponds to a third audio subband, and the fourth reconstructed subband audio signal corresponds to a fourth audio subband, wherein the third audio subband is distinct from the first audio subband and the second audio subband, and wherein the fourth audio subband is distinct from the first audio subband, the second audio subband, and the third audio subband.

Example 35 includes the method of any of Example 27 to Example 34, wherein a first particular audio subband corresponds to a first range of frequencies, wherein a second particular audio subband corresponds to a second range of frequencies, and wherein the first particular audio subband includes one of the first audio subband, the second audio subband, a third audio subband, or a fourth audio subband, and wherein the second particular audio subband includes another one of the first audio subband, the second audio subband, the third audio subband, or the fourth audio subband.

Example 36 includes the method of Example 35, wherein the first range of frequencies has a first width that is greater than or equal to a second width of the second range of frequencies.

Example 37 includes the method of Example 35 or Example 36, wherein the first range of frequencies at least partially overlaps the second range of frequencies.

Example 38 includes the method of Example 35 or Example 36, wherein the first range of frequencies is adjacent to the second range of frequencies.

Example 39 includes the method of any of Example 27 to Example 38, wherein a recurrent layer of the neural network includes a gated recurrent unit (GRU).

Example 40 includes the method of any of Example 27 to Example 39, wherein the one or more neural network inputs also include predicted audio data.

Example 41 includes the method of Example 40, wherein the predicted audio data includes long-term prediction (LTP) data, linear prediction (LP) data, or a combination thereof.

Example 42 includes the method of any of Example 27 to Example 41, wherein the one or more neural network inputs also include linear prediction (LP) prediction of at least one subband audio sample, LP residual of at least one previous subband audio sample, the at least one previous subband audio sample, the at least one previous reconstructed audio sample, or a combination thereof.

Example 43 includes the method of any of Example 27 to Example 42, wherein the first subband neural network includes a first neural network that is configured to process the one or more first subband network inputs to generate first residual data.

Example 44 includes the method of Example 43, wherein the first subband neural network further includes a first linear prediction (LP) filter configured to process the first residual data based on linear predictive coefficients (LPCs) to generate the at least one first subband audio sample.

Example 45 includes the method of Example 44, wherein the first LP filter includes a long-term prediction (LTP) filter, a short-term LP filter, or both.

Example 46 includes the method of Example 44 or Example 45, further including: receiving, via a modem, encoded audio data from a second device; decoding the encoded audio data to generate feature data of the audio frame; and estimating the LPCs based on the feature data.

Example 47 includes the method of Example 44 or Example 45, further including: receiving, via a modem, encoded audio data from a second device; and decoding the encoded audio data to generate the LPCs.

Example 48 includes the method of any of Example 27 to Example 47, wherein the one or more second subband network inputs also include linear prediction (LP) prediction of at least one subband audio sample, LP residual of at least one previous subband audio sample, the at least one previous subband audio sample, the at least one previous reconstructed audio sample, LP residual of the at least one first subband audio sample, the at least one first subband audio sample, or a combination thereof.

Example 49 includes the method of any of Example 27 to Example 48, wherein the one or more first subband network inputs also include linear prediction (LP) prediction of at least one subband audio sample, LP residual of at least one previous subband audio sample, the at least one previous subband audio sample, the at least one previous reconstructed audio sample, or a combination thereof.

Example 50 includes the method of any of Example 27 to Example 49, wherein the reconstructor is further configured to provide the audio frame to a speaker.

Example 51 includes the method of any of Example 27 to Example 50, wherein the reconstructor includes a subband reconstruction filterbank.

Example 52 includes the method of any of Example 27 to Example 51, wherein the at least one reconstructed audio sample includes a plurality of audio samples.

Example 53 includes the method of any of Example 27 to Example 52, wherein the reconstructed audio signal includes a reconstructed speech signal.

According to Example 54, a device includes a memory configured to store instructions; and a processor configured to execute the instructions to perform the method of any of Example 27 to Example 53.

According to Example 55, a non-transitory computer-readable medium stores instructions that, when executed by a processor, cause the processor to perform the method of any of Example 27 to Example 53.

According to Example 56, a computer program product comprising computer program instructions that, when executed by a processor, cause the processor to perform the method of any of Example 27 to Example 53.

According to Example 57, an apparatus includes means for carrying out the method of any of Example 27 to Example 53.

According to Example 58, a non-transitory computer-readable medium stores instructions that, when executed by one or more processors, cause the one or more processors to: process, using a neural network, one or more neural network inputs to generate a neural network output, the one or more neural network inputs including at least one previous audio sample; process, using a first subband neural network, one or more first subband network inputs to generate at least one first subband audio sample of a first reconstructed subband audio signal; process, using a second subband neural network, one or more second subband network inputs to generate at least one second subband audio sample of a second reconstructed subband audio signal; and generate, based on the at least one first subband audio sample and the at least one second subband audio sample, at least one reconstructed audio sample of an audio frame of a reconstructed audio signal, wherein the at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof, and wherein the one or more second subband network inputs to the second subband neural network include the at least one previous second subband audio sample, the at least one previous reconstructed audio sample, the at least one first subband audio sample, the at least one previous first subband audio sample, the neural network output, or a combination thereof.

According to Example 59, a non-transitory computer-readable medium stores instructions that, when executed by one or more processors, cause the one or more processors to: process, using a neural network, one or more neural network inputs to generate a neural network output, the one or more neural network inputs including at least one previous audio sample; process, using a first subband neural network, one or more first subband network inputs to generate at least one first subband audio sample of a first reconstructed subband audio signal, the one or more first subband network inputs including at least the neural network output, wherein the first reconstructed subband audio signal corresponds to a first audio subband; process, using a second subband neural network, one or more second subband network inputs to generate at least one second subband audio sample of a second reconstructed subband audio signal, the one or more second subband network inputs including at least the neural network output, wherein the second reconstructed subband audio signal corresponds to a second audio subband that is distinct from the first audio subband; and generate, based on the at least one first subband audio sample and the at least one second subband audio sample, at least one reconstructed audio sample of an audio frame of a reconstructed audio signal, wherein the at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

Example 60 includes the non-transitory computer-readable medium of Example 58, wherein the instructions, when executed by the one or more processors, also cause the one or more processors to: process, using a third subband neural network, one or more third subband network inputs to generate at least one third subband audio sample of a third reconstructed subband audio signal; and process, using a fourth subband neural network, one or more fourth subband network inputs to generate at least one fourth subband audio sample of a fourth reconstructed subband audio signal, wherein the at least one reconstructed audio sample is further based on the at least one third subband audio sample, the at least one fourth subband audio sample, or a combination thereof.

According to Example 61, an apparatus includes: means for processing, using a neural network, one or more neural network inputs to generate a neural network output, the one or more neural network inputs including at least one previous audio sample; means for processing, using a first subband neural network, one or more first subband network inputs to generate at least one first subband audio sample of a first reconstructed subband audio signal; means for processing, using a second subband neural network, one or more second subband network inputs to generate at least one second subband audio sample of a second reconstructed subband audio signal; and means for generating, based on the at least one first subband audio sample and the at least one second subband audio sample, at least one reconstructed audio sample of an audio frame of a reconstructed audio signal, wherein the at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof, and wherein the one or more second subband network inputs to the second subband neural network include the at least one previous second subband audio sample, the at least one previous reconstructed audio sample, the at least one first subband audio sample, the at least one previous first subband audio sample, the neural network output, or a combination thereof.

According to Example 62, an apparatus includes: means for processing, using a neural network, one or more neural network inputs to generate a neural network output, the one or more neural network inputs including at least one previous audio sample; means for processing, using a first subband neural network, one or more first subband network inputs to generate at least one first subband audio sample of a first reconstructed subband audio signal, the one or more first subband network inputs including at least the neural network output, wherein the first reconstructed subband audio signal corresponds to a first audio subband; means for processing, using a second subband neural network, one or more second subband network inputs to generate at least one second subband audio sample of a second reconstructed subband audio signal, the one or more second subband network inputs including at least the neural network output, wherein the second reconstructed subband audio signal corresponds to a second audio subband that is distinct from the first audio subband; and means for generating, based on the at least one first subband audio sample and the at least one second subband audio sample, at least one reconstructed audio sample of an audio frame of a reconstructed audio signal, wherein the at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

Example 63 includes the apparatus of Example 62, wherein the means for processing using the neural network, the means for processing using the first subband neural network, the means for processing using the second subband neural network, and the means for generating are integrated into at least one of a smart speaker, a speaker bar, a computer, a tablet, a display device, a television, a gaming console, a music player, a radio, a digital video player, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a communication device, an internet-of-things (IoT) device, a virtual reality (VR) device, a base station, or a mobile device.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A device comprising:
a neural network configured to process one or more neural network inputs to generate a neural network output, the one or more neural network inputs including at least one previous audio sample;
a first subband neural network configured to process one or more first subband network inputs to generate at least one first subband audio sample of a first reconstructed subband audio signal, the one or more first subband network inputs including at least the neural network output, wherein the first reconstructed subband audio signal corresponds to a first audio subband;
a second subband neural network configured to process one or more second subband network inputs to generate at least one second subband audio sample of a second reconstructed subband audio signal, the one or more second subband network inputs including at least the neural network output, wherein the second reconstructed subband audio signal corresponds to a second audio subband that is distinct from the first audio subband; and
a reconstructor configured to generate, based on the at least one first subband audio sample and the at least one second subband audio sample, at least one reconstructed audio sample of an audio frame of a reconstructed audio signal,
wherein the at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

2. The device of claim 1, wherein the reconstructor is configured to generate multiple reconstructed audio samples of the reconstructed audio signal per inference of the neural network, wherein the first subband neural network operates at a sample rate of the reconstructed audio signal, and wherein the second subband neural network operates at the sample rate of the reconstructed audio signal.

3. The device of claim 1, wherein the one or more first subband network inputs to the first subband neural network further include the at least one previous first subband audio sample, the at least one previous second subband audio sample, the at least one previous reconstructed audio sample, or a combination thereof, and wherein the one or more second subband network inputs to the second subband neural network further include the at least one first subband audio sample, the at least one previous second subband audio sample, the at least one previous reconstructed audio sample, the at least one previous first subband audio sample, or a combination thereof.

4. The device of claim 1, further comprising one or more additional subband neural networks configured to generate at least one additional subband audio sample of one or more additional subband audio signals, wherein the at least one reconstructed audio sample is further based on the at least one additional subband audio sample.

5. The device of claim 1, further comprising:
a third subband neural network configured to process one or more third subband network inputs to generate at least one third subband audio sample of a third reconstructed subband audio signal; and
a fourth subband neural network configured to process one or more fourth subband network inputs to generate at least one fourth subband audio sample of a fourth reconstructed subband audio signal,
wherein the at least one reconstructed audio sample is further based on the at least one third subband audio sample, the at least one fourth subband audio sample, or a combination thereof.

6. The device of claim 5, wherein the one or more third subband network inputs to the third subband neural network include the at least one second subband audio sample and the neural network output, and wherein the one or more fourth subband network inputs to the fourth subband neural network include the at least one third subband audio sample and the neural network output.

7. The device of claim 5, wherein the third reconstructed subband audio signal corresponds to a third audio subband, and the fourth reconstructed subband audio signal corresponds to a fourth audio subband, wherein the third audio subband is distinct from the first audio subband and the second audio subband, and wherein the fourth audio subband is distinct from the first audio subband, the second audio subband, and the third audio subband.

8. The device of claim 1, wherein a first particular audio subband corresponds to a first range of frequencies, wherein a second particular audio subband corresponds to a second range of frequencies, and wherein the first particular audio subband includes one of the first audio subband, the second audio subband, a third audio subband, or a fourth audio subband, and wherein the second particular audio subband includes another one of the first audio subband, the second audio subband, the third audio subband, or the fourth audio subband.

9. The device of claim 8, wherein the first range of frequencies has a first width that is greater than or equal to a second width of the second range of frequencies.

10. The device of claim 8, wherein the first range of frequencies at least partially overlaps the second range of frequencies.

11. The device of claim 8, wherein the first range of frequencies is adjacent to the second range of frequencies.

12. The device of claim 1, wherein a recurrent layer of the neural network includes a gated recurrent unit (GRU).

13. The device of claim 1, wherein the one or more neural network inputs also include predicted audio data.

14. The device of claim 13, wherein the predicted audio data includes long-term prediction (LTP) data, linear prediction (LP) data, or a combination thereof.

15. The device of claim 1, wherein the one or more neural network inputs also include linear prediction (LP) prediction of at least one subband audio sample, LP residual of at least one previous subband audio sample, the at least one previous subband audio sample, the at least one previous reconstructed audio sample, or a combination thereof.

16. The device of claim 1, wherein the first subband neural network comprises a first neural network that is configured to process the one or more first subband network inputs to generate first residual data.

17. The device of claim 16, wherein the first subband neural network further comprises a first linear prediction (LP) filter configured to process the first residual data based on linear predictive coefficients (LPCs) to generate the at least one first subband audio sample.

18. The device of claim 17, wherein the first LP filter includes a long-term prediction (LTP) filter, a short-term LP filter, or both.

19. (canceled)

20. The device of claim 17, further comprising:
a modem configured to receive encoded audio data from a second device; and
a decoder configured to decode the encoded audio data to generate the LPCs.

21. The device of claim 1, wherein the one or more second subband network inputs also include linear prediction (LP) prediction of at least one subband audio sample, LP residual of at least one previous subband audio sample, the at least one previous subband audio sample, the at least one previous reconstructed audio sample, LP residual of the at least one first subband audio sample, the at least one first subband audio sample, or a combination thereof.

22. The device of claim 1, wherein the one or more first subband network inputs also include linear prediction (LP) prediction of at least one subband audio sample, LP residual of at least one previous subband audio sample, the at least one previous subband audio sample, the at least one previous reconstructed audio sample, or a combination thereof.

23-26. (canceled)

27. A method comprising:
processing, using a neural network, one or more neural network inputs to generate a neural network output, the one or more neural network inputs including at least one previous audio sample;
processing, using a first subband neural network, one or more first subband network inputs to generate at least one first subband audio sample of a first reconstructed subband audio signal, the one or more first subband network inputs including at least the neural network output, wherein the first reconstructed subband audio signal corresponds to a first audio subband;
processing, using a second subband neural network, one or more second subband network inputs to generate at least one second subband audio sample of a second reconstructed subband audio signal, the one or more second subband network inputs including at least the neural network output, wherein the second reconstructed subband audio signal corresponds to a second audio subband that is distinct from the first audio subband; and
using a reconstructor to generate, based on the at least one first subband audio sample and the at least one second subband audio sample, at least one reconstructed audio sample of an audio frame of a reconstructed audio signal,
wherein the at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

28. (canceled)

29. A non-transitory computer-readable medium storing instructions that, when executed by one or more processors, cause the one or more processors to:
process, using a neural network, one or more neural network inputs to generate a neural network output, the one or more neural network inputs including at least one previous audio sample;
process, using a first subband neural network, one or more first subband network inputs to generate at least one first subband audio sample of a first reconstructed subband audio signal, the one or more first subband network inputs including at least the neural network output, wherein the first reconstructed subband audio signal corresponds to a first audio subband;
process, using a second subband neural network, one or more second subband network inputs to generate at least one second subband audio sample of a second reconstructed subband audio signal, the one or more second subband network inputs including at least the neural network output, wherein the second reconstructed subband audio signal corresponds to a second audio subband that is distinct from the first audio subband; and
generate, based on the at least one first subband audio sample and the at least one second subband audio sample, at least one reconstructed audio sample of an audio frame of a reconstructed audio signal,
wherein the at least one previous audio sample includes at least one previous first subband audio sample of the first reconstructed subband audio signal, at least one previous second subband audio sample of the second reconstructed subband audio signal, at least one previous reconstructed audio sample of the reconstructed audio signal, or a combination thereof.

30-32. (canceled)
